(19) United States
(12) Patent Application Publication
(10) Pub. No.: US 2023/0070713 A1
(43) Pub. Date: Mar. 9, 2023

(54) HEATER FOR ELECTRIC STOVETOP HEATER UNIT

(71) Applicant: Zoppas Industries de Mexico S.A., de C.V., San Luis Potosi (MX)

(72) Inventors: Jose Jesus Reyes Soto, San Luis Potosi (MX); Jose Amparo Lopez, JR., San Luis Potosi (MX); Maurizio Francesco Pasqual, San Luis Potosi (MX); Alfredo Cuevas Morales, San Luis Potosi (MX)

(21) Appl. No.: 17/940,869

(22) Filed: Sep. 8, 2022

Related U.S. Application Data
(60) Provisional application No. 63/241,855, filed on Sep. 8, 2021.

(51) Int. Cl. F24C 7/08; H05B 1/02; H05B 3/28

(52) U.S. Cl. CPC F24C 7/083; H05B 1/0266; H05B 3/28; H05B 2213/07; H05B 2213/04

(57) ABSTRACT

A heater for a stovetop heater unit is disclosed. The heater may reduce false detections of an overheat condition, minimize an impact of radiative heat from a heating element of the heater on temperature measurements of the heater, and accurately measure a temperature of an object placed on the heater. Thus, the heater may reduce an amount of time required to heat an object placed on the heater.

### CROSS-REFERENCE TO RELATED APPLICATIONS

The present application claims priority to U.S. Provisional Application No. 63/241,855, filed Sep. 8, 2021, and entitled “Heater for Electric Stovetop Heater Unit,” the entirety of which is incorporated by reference herein.

### FIELD

The subject matter described herein generally relates to electric stovetop heater units and more specifically relates to heaters for electric stovetop heater units.

### BACKGROUND

Heaters are used to provide heat to an object by converting electrical current in the heating element into thermal energy. The thermal energy is typically transferred to the object by conduction between the object and the heating element. The temperature of a heater may be varied by adjusting the amount of current flowing through the heating element until a desired thermal equilibrium is reached between the heating element and the object in thermal contact with the heating element. When an object is placed onto the heating element, such that the object is in thermal contact with the heating element, the object may be stably supported to provide accurate temperature readings.

### SUMMARY

Systems and methods for heaters of electric stovetop heater units are disclosed.

According to some aspects, a heater for a stovetop heater unit includes a heating element and a temperature sensor. The heating element may be in a spiral configuration. The heating element may include an inner portion and an outer portion. The inner portion may extend, in the spiral configuration, about a central region. The inner portion may have a first temperature when current is supplied to the heating element. The outer portion may extend, in the spiral configuration, radially and outwardly from the inner portion. The outer portion may have a second temperature when current is supplied to the heating element. The second temperature may be higher than the first temperature. The inner portion and the outer portion together define a surface heating portion upon which an object is placed. The temperature sensor may be positioned within the central region. The central region may not contain the surface heating portion.

In some aspects, the heating element further includes a resistive wire and a sheath. The resistive wire may include a first coil portion positioned within the inner portion of the heating element and a second coil portion positioned within the outer portion of the heating element. The sheath may surround the resistive wire.

In some aspects, the first coil portion is stretched relative to the second coil portion, thereby reducing the first temperature of the heat generated by the inner portion of the heating element.

In some aspects, the first coil portion includes one or more first coils. Each of the one or more first coils may be spaced apart by a first gap. The second coil portion includes one or more second coils. Each of the one or more second coils may be spaced apart by a second gap. The first gap is greater than the second gap, thereby reducing the first temperature of the heat generated by the inner portion of the heating element.

In some aspects, the inner portion is coated with an insulator. The insulator may cause the first temperature to be less than the second temperature.

In some aspects, the inner portion has a length of 356 mm.

In some aspects, the outer portion has a length of 1763 mm.

In some aspects, the outer portion has a length of 1748 mm to 1778 mm.

In some aspects, a ratio of a length of the outer portion to a length of the inner portion is 4.95.

In some aspects, a ratio of a length of the outer portion to a length of the inner portion is 4.9 to 5.0.

In some aspects, a distance between a center of the central region and an innermost portion of the inner portion is 52.6 mm.

In some aspects, a distance between a center of the central region and an outermost portion of the inner portion is 59.7 mm.

In some aspects, a distance between a center of the central region and an innermost portion of the inner portion is 50 mm to 55 mm.

In some aspects, a distance between a center of the central region and an outermost portion of the inner portion is 55 mm to 65 mm.

In some aspects, the heater includes an urging element configured to mechanically deform to provide vertical movement of the temperature sensor in response to a downward force applied from the object to the temperature sensor.

In some aspects, the urging element includes: a plurality of planar sections connected at an angle, the vertical movement being caused by a restorative force to restore the angle between the plurality of planar sections.

In some aspects, the heater includes a switch configured to prevent a current from conducting through the heating element when the temperature sensor detects a temperature equal to or greater than a temperature threshold.

In some aspects, the switch allows the current to conduct through the heating element when the temperature sensor detects the temperature is less than the threshold temperature.

According to some aspects, a heater for a stovetop unit includes a heating element in a spiral configuration, a temperature sensor, a first terminal coupled to a power source, and a first conductor defining a first cold pin that does not generate heat. The heating element includes an inner portion extending, in the spiral configuration, about a central region and an outer portion extending, in the spiral configuration, radially and outwardly from the inner portion. The outer portion generates heat. The inner portion and the outer portion together define a surface heating portion upon which an object is placed to be heated. The temperature sensor is positioned within the central region. The central region does not contain the surface heating portion. The first conductor extends between the first terminal and the outer portion of the heating element. The first conductor includes the inner portion of the heating element.

In some aspects, the heater includes a second terminal configured to be coupled to the power source and a second conductor defining a second cold pin that does not generate heat. The second conductor extends between the second terminal and the temperature sensor.

In some aspects, the first terminal, the first conductor, the thermostat, the second conductor, and the second terminal are electrically coupled in series.

According to some aspects, a heater for a stovetop heater unit includes a heating element in a spiral configuration and a temperature sensor. The heating element includes an innermost coil turn extending, in the spiral configuration, about a central region. The innermost coil turn defines at least a part of a surface heating portion upon which an object is placed to be heated by the heating element. The temperature sensor is positioned within the central region. The central region does not contain the surface heating portion. A minimum radius of the central region is 45.5 mm to 54.5 mm.

In some aspects, the heating element includes three to four coil turns. The innermost coil turn is at least one of the three to four coil turns. In some aspects, the heating element includes three to five coil turns. The innermost coil turn is at least one of the three to five coil turns.

In some aspects, the minimum radius is equal to a minimum distance between a center of the temperature sensor and the innermost coil turn.

In some aspects, the minimum radius of the central region is 45.5 mm.

In some aspects, a maximum radius of the central region is 54.5 mm.

In some aspects, the minimum radius of the central region is 48.8 mm.

In some aspects, the heater may also include a medallion. The medallion may include a medallion aperture shaped to allow at least a portion of the temperature sensor to extend through the medallion aperture. A minimum distance between a radially-outward-most surface of the medallion and the innermost coil turn is 16 mm to 25 mm.

In some aspects, the heater includes a housing configured to surround at least a portion of the temperature sensor. A minimum distance between a radially-outward-most surface of the housing and the innermost coil turn is 16 mm to 25 mm.

In some aspects, a maximum radius of the central region is 57.6 mm to 66.6 mm.

In some aspects, the heater includes an outermost coil turn extending, in the spiral configuration, about the central region of the heating element and the innermost coil turn. The outermost coil turn defines at least a part of the surface heating portion.

In some aspects, an outermost radius between a center of the central region and the outermost coil turn is 95.2 mm.

In some aspects, an outermost radius between a center of the central region and the outermost coil turn is 87.7 mm.

In some aspects, the heater includes a resistive wire configured to generate heat to heat the heating element and a sheath surrounding the resistive wire. The resistive wire extends through at least the innermost coil turn.

In some aspects, the surface heating portion has a length of 1740 mm.

In some aspects, the surface heating portion has a length of 1725 mm to 1755 mm.

According to some aspects, a heater for a stovetop heater unit includes a heating element, a thermostat, a medallion, and a heat collector. The thermostat includes a temperature sensing portion configured to measure a temperature of an object placed on the heating element. The medallion includes a surface and a medallion aperture. The surface faces towards the object placed on the heating element. The medallion aperture is shaped to allow at least the temperature sensing portion to extend through the medallion aperture. The heat collector is coupled to the temperature sensing portion of the thermostat and extends over at least the surface of the medallion and the temperature sensing portion of the thermostat. The heat collector absorbs heat from the object placed on the heating element. The heat collector also amplifies a sensing rate of the temperature sensing portion of the thermostat.

In some aspects, the heat collector is disc shaped.

In some aspects, the heat collector further extends to an outer edge of the surface.

In some aspects, the heat collector has a heat collector diameter that is equal to a medallion diameter of the medallion.

In some aspects, the heat collector includes a heat collection surface configured to contact the object placed on the heating element, an outermost edge, and a beveled lateral surface that extends radially outwardly from the heat collection surface towards the outermost edge.

In some aspects, the outermost edge of the heat collector is longitudinally aligned with an outermost edge of the surface of the medallion.

In some aspects, the outermost edge includes a first diameter. The surface of the medallion includes a second diameter that is equal to the first diameter.

In some aspects, the heat collection surface includes a first diameter. The outermost edge includes a second diameter that is greater than the first diameter.

In some aspects, the first diameter is 40 mm to 41 mm. The second diameter is 50 mm.

In some aspects, the beveled lateral surface extends from the heat collection surface to the outermost edge.

In some aspects, the heat collector further includes a lateral-facing surface. The lateral-facing surface includes the outermost edge. The beveled lateral surface extends from the heat collection surface to the lateral-facing surface.

In some aspects, the heat collector includes aluminum.

In some aspects, the heat collector is coupled to the thermostat via one or more of a press-fit connection, an adhesive, a screw, a rivet, a thread fit, and an ultrasonic process.

According to some aspects, a heater for a stovetop heater unit includes a heating element, a medallion, and a thermocouple. The heating element has a region that does not contain a surface heating portion of the heating element. The medallion is positioned within the region. The medallion is configured to contact an object placed on the surface heating portion of the heating element. The thermocouple is positioned in the region. The thermocouple is coupled to the medallion. The thermocouple is configured to detect a temperature of the object placed on the surface heating portion of the heating element and in contact with the medallion. The thermocouple is configured to prevent a current from conducting through the heating element when the thermocouple detects a temperature of the medallion greater than or equal to a temperature limit.

In some aspects, the medallion includes a raised central portion. The raised central portion is configured to contact the object. The raised central portion is configured to be coupled to the thermocouple.

In some aspects, the thermocouple is welded to the medallion.

In some aspects, the heater includes a housing coupled to the medallion. The medallion covers an opening into the housing.

In some aspects, the heater includes an urging element coupled to the medallion. The urging element is configured to mechanically deform to provide vertical movement of the medallion in response to a downward force applied from the object to the medallion.

In some aspects, the urging element further includes a central aperture. The thermocouple passes through the central aperture.

In some aspects, the heater includes a thermocouple contact extending from the thermocouple. The thermocouple contact communicates with the control system.

In some aspects, the heater includes a first terminal and a second terminal. The first terminal is coupled to the surface heating portion of the heating element. The first terminal is configured to be coupled to a control system configured to control the current conducting through the heating element. A second terminal is coupled to the thermocouple. The second terminal is configured to be coupled to the control system.

In some aspects, the first terminal and the second terminal are not electrically coupled when the heater is disconnected from the control system.

In some aspects, the first terminal and the second terminal are not electrically coupled in series when the heater is disconnected from the control system.

In some aspects, the first terminal and the second terminal are electrically coupled in series with the control system when the heater is connected to the control system.

In some aspects, the thermocouple is electrically coupled to a control system. The control system may include at least one data processor and at least one memory storing instructions which, when executed by the at least one data processor, result in operations including: controlling the current conducting through the heating element.

According to some aspects, a heater for a stovetop heater unit includes a heating element having a region that does not contain a surface heating portion of the heating element, a thermostat positioned in the region, a housing, and an urging element positioned at least partially within an interior of the housing. The thermostat includes a base, a thermostat body, and a cap coupled to the thermostat body. The cap is configured to make physical contact with an object positioned on the surface heating portion, thereby allowing the thermostat to detect a temperature of the object. The urging element is configured to mechanically deform to provide vertical movement of the thermostat in response to a downward force applied from the object to the cap. The cap is configured to extend over and cover the interior of the housing.

In some aspects, the heater includes a terminal connector coupled to the thermostat and configured to be coupled to a terminal of the heater.

In some aspects, the thermostat body includes ceramic.

In some aspects, the base includes stainless steel.

In some aspects, the cap includes aluminum.

In some aspects, the urging element is coupled to the base.

In some aspects, the cap includes a flat contact surface configured to make physical contact with the object.

In some aspects, the cap includes a protrusion extending from the flat contact surface into an interior of the cap. The protrusion is configured to couple with the thermostat body.

In some aspects, the heater includes a switch configured to prevent a current from conducting through the heating element when the cap experiences a temperature that is greater than or equal to a threshold temperature.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to particular implementations, it should be readily understood that such features are not intended to be limiting. The claims that follow this disclosure are intended to define the scope of the protected subject matter.

### BRIEF DESCRIPTION OF THE DRAWINGS

The accompanying drawings, which are incorporated in and constitute a part of this specification, show certain implementations of the subject matter disclosed herein and, together with the description, help explain some of the principles associated with the disclosed implementations. In the drawings,

FIG. 1 is a diagram illustrating a simplified bottom view of an example heater consistent with implementations of the current subject matter;

FIG. 2 is a diagram illustrating a simplified top view of an example heater consistent with implementations of the current subject matter;

FIG. 3 is a diagram illustrating a simplified perspective view of an example heater consistent with implementations of the current subject matter;

FIG. 4 is a perspective view of an example heater consistent with implementations of the current subject matter;

FIG. 5 is a diagram illustrating a perspective view of a thermostat incorporating a contact surface extending through a medallion consistent with implementations of the current subject matter;

FIG. 6 is a diagram illustrating a simplified close-up perspective view of a thermostat incorporating a contact surface extending through a medallion consistent with implementations of the current subject matter;

FIG. 7 is a bottom view of a thermostat, a bracket, and a housing open to show the thermostat and bracket consistent with implementations of the current subject matter;

FIG. 8 depicts an example bracket consistent with implementations of the current subject matter;

FIG. 9 depicts an example heater consistent with implementations of the current subject matter;

FIG. 10 depicts an example heater consistent with implementations of the current subject matter;

FIG. 11 depicts an example heater consistent with implementations of the current subject matter;

FIG. 12 depicts a portion of an example resistive wire of a heater consistent with implementations of the current subject matter;

FIG. 13 depicts an example heater consistent with implementations of the current subject matter;

FIG. 14A depicts an example heater consistent with implementations of the current subject matter;

FIG. 14B depicts an example heater consistent with implementations of the current subject matter;

FIG. 15A depicts an example heater consistent with implementations of the current subject matter;

FIG. 15B depicts an example heater consistent with implementations of the current subject matter;

FIG. 16 depicts an example heater consistent with implementations of the current subject matter;

FIG. 17 is a table showing results of tests performed using heaters consistent with implementations of the current subject matter;

FIG. 18 depicts an example heater having a heat collector consistent with implementations of the current subject matter;

FIG. 19 depicts an example heat collector for a heater consistent with implementations of the current subject matter;

FIGS. 20A-20D depict an example heat collector for a heater consistent with implementations of the current subject matter;

FIG. 21 depicts an cross-sectional view of an example heater consistent with implementations of the current subject matter;

FIG. 22 depicts an example heater control system consistent with implementations of the current subject matter;

FIG. 23 is a graph showing results of tests performed using a heater consistent with implementations of the current subject matter;

FIG. 24 depicts a thermostat of an example heater consistent with implementations of the current subject matter;

FIG. 25 depicts a thermostat of an example heater consistent with implementations of the current subject matter; and

FIG. 26 depicts a cross-sectional view of a thermostat of an example heater consistent with implementations of the current subject matter.

### DETAILED DESCRIPTION

Heating elements, such as those used in stovetop burners and hot plates, may be used to heat objects or prepare food. As described herein, heating elements may provide heat to a desired object primarily by the conduction of heat from the heating element to the object placed on top of, or otherwise in contact with, the heating element. The heating element may also contribute heat to the object in the form of radiative heat transfer.

An electrical current passed through the heating element may cause resistive heating of the heating element. The direction of current flow through any of the elements described herein is arbitrary and may go in any direction consistent with the applied power source. The steady-state temperature of the heating element may be based on achievement of thermal equilibrium between the power dissipated during the resistive heating and the power radiated or conducted away by the objects or the medium in contact with the heating element. During the heating process, the temperature of the heating element increases until thermal equilibrium is reached. Because an object, for example, a pan with water, may act as a substantial heat sink, the heating element may obtain a different final temperature than it would in the absence of an object being heated.

Because the temperature of the heating element may vary substantially depending on the various heat sinks, an un-monitored or unregulated supply of current to the heating element may cause the heating element to overheat. An overheated heating element may damage an object that is unable to dissipate the heat from the heating element. Also, an overheated heating element may damage the heating element itself, through mechanical failure, melting, or enhanced degradation of the heating element, or may result in a fire or the production of unhealthy combustion or thermal degradation by-products.

By providing a direct measurement of the temperature of the heating element and/or the object placed on the heating element, an overheat condition may be detected. The current to the heating element may then be reduced or stopped in order to avoid the overheating condition, and may be supplied to the heating element when the overheating condition is removed.

In some instances, a thermostat may be provided at the center of the heating element to measure the temperature of the object placed on the heating element and to detect the overheating condition. Due to the positioning of the thermostat relative to the heated portions of the heating element, the thermostat may not only be impacted by the temperature of the object placed on the heating element, but also the heating element itself. For example, while the thermostat may generally measure the temperature of the object placed on the heating element via conduction, the thermostat is also impacted by the heat generated by the heating element via radiation.

Due to both the conductive heat from the object and the radiative heat from the heating element, the thermostat may inaccurately record a high temperature indicative of the overheat condition, even in circumstances when no overheat condition exists. As a result, current supplied to the heating element may be reduced or prevented prematurely and/or at improper times while heating the object placed on the heating element. Such circumstances may thus undesirably result in an extended amount of time to heat the object placed on the heating element and/or an improperly heated object, since one or more overheating conditions may be falsely detected while heating the object placed on the heating element. Such circumstances may additionally and/or alternatively damage the heating element or reduce a life cycle of the heating element due to an increase in the number of times current is supplied and/or cut-off from being supplied to the heating element during operation.

The heater consistent with implementations of the current subject matter improves the accuracy of temperature readings by the thermostat and thus, reduces or eliminates false detection of overheat conditions, thereby resulting in more consistent and faster heating times for objects placed on the heater.

For example, in some implementations, the heater may include a heating element in a spiral configuration. The heating element may include an inner portion, extending in the spiral configuration, about a central region, in which a temperature sensor is located, and an outer portion extending, in the spiral configuration, radially and outwardly from the inner portion. The outer portion may have a higher temperature than the inner portion during operation of the heating element, such as when current is supplied to the heating element. Such configurations may reduce an impact of the radiative heat generated by the heating element on the temperature sensor.

Additionally and/or alternatively, the heater may include a heating element in a spiral configuration. The heating element may include an inner portion, extending in the spiral configuration, about a central region, in which a temperature sensor is located, and an outer portion, which may generate heat, extending, in the spiral configuration, radially and outwardly from the inner portion. The heater may also include a first terminal and/or a second terminal configured to be coupled to a power source. The heater may also include a first conductor defining a first cold pin that does not generate heat. The first conductor may extend between the first terminal and the outer portion of the heating element, and include the inner portion of the heating element. In some implementations, the heater includes a second conductor defining a second cold pin that does not generate heat. The second conductor may extend between the first terminal and the temperature sensor. Since the heat generating portion of the heating element (e.g., the outer portion) may be positioned farther away from the temperature sensor, the heater may reduce an impact of the radiative heat generated by the heating element on the temperature sensor.

Additionally and/or alternatively, the heater may include a heating element and a thermostat including a temperature sensing portion that measures a temperature of an object placed on the heating element. The heater may also include a medallion that has a surface configured to face towards the object, and a medallion aperture shaped to allow at least the temperature sensing portion to extend therethrough. The heater may further include a heat collector coupled to at least the temperature sensing portion of the thermostat and extending over at least the surface of the medallion and the temperature sensing portion of the thermostat. The heat collector may absorb heat from the object placed on the heating element. The heat collector may evenly distribute the absorbed heat throughout the heat collector. Thus, even in instances when the heat collector also absorbs some radiative heat from the heating element, the heat collector minimizes the impact of the radiative heat by distributing the absorbed heat. Such configurations may amplify a sensing rate of the temperature sensing portion of the thermostat and provide a platform having a uniform temperature that is measured by the temperature sensing portion of the thermostat, thereby improving the accuracy of the temperature measurements and reducing false detection of an overheat condition. Such configurations may additionally and/or alternatively absorb heat from the object and transfer the heat reading of the object to the temperature sensing portion to provide an improved response of the thermostat. For example, such configurations may allow for a switch of the heater to quickly prevent or limit current being supplied to the heating element based on faster detection of the overheat condition.

Additionally and/or alternatively, the heater may include a heating element in a spiral configuration. The heating element may include an innermost coil turn extending, in the spiral configuration, about a central region, in which a temperature sensor is located. The innermost coil turn may define at least a part of a surface heating portion upon which an object is placed to be heated by the heating element. The innermost coil turn may be positioned at a desirable distance away from the temperature sensor to minimize the impact of the radiative heat from the heating element on the temperature sensor. For example, the central region, in which the temperature sensor is located, may have a minimum radius of approximately 45.5 mm to 54.5 mm.

Additionally and/or alternatively, a heater may include a heating element having a region that does not contain a surface heating portion. The heater may also include a medallion, which may contact an object placed on the surface heating portion, positioned within the region. The heater may further include a thermocouple positioned in the region and coupled to the medallion. The thermocouple may detect a temperature of the object placed on the surface heating portion and in contact with the medallion. The thermocouple may more directly measure the temperature of the object, thereby improving the accuracy of temperature measurements and reducing an impact of radiative heat emitted from the heating element. As described in more detail herein, the thermocouple may detect the temperature of the object, such as via the medallion. The thermocouple may be coupled with a control system that converts the electrical measurement signals from the thermocouple (or another temperature sensor) to a temperature and compares the temperature to a threshold temperature. Based on the detected temperature and/or the comparison, the control system may regulate the temperature of the object. For example, the control system may prevent current from being supplied to the heater (e.g., turn the heater off) or allow current to be supplied to the heater (e.g., turn the heater on). Depending on the detected temperature and/or the comparison, the control system may cycle between supplying and/or preventing current from being supplied to the heater. As noted above, the thermocouple allows for direct, quick, and accurate measurements, which allows for more consistent temperature readings, and a reduced temperature differential between the temperature of the object and detected temperature.

Additionally and/or alternatively, the heater may include a heating element having a region that does not contain a surface heating portion. The heater may further include a thermostat positioned in the region and including a base, a thermostat body, and a cap coupled to the thermostat body. The cap may make physical contact with an object positioned on the surface heating portion, thereby allowing the thermostat to detect a temperature of the object. The cap may extend over and cover an interior of a housing that surrounds at least a portion of the thermostat and/or an urging element of the heater. The cap of the thermostat may absorb heat from the object placed on the heating element. The cap may evenly distribute the absorbed heat throughout the cap. Thus, even in instances when the cap also absorbs some radiative heat from the heating element, the cap minimizes the impact of the radiative heat by distributing the absorbed heat. Such configurations may amplify a sensing rate of the thermostat and provide a platform having a uniform temperature that is measured by the thermostat, thereby improving the accuracy of the temperature measurements and reducing false detection of an overheat condition.

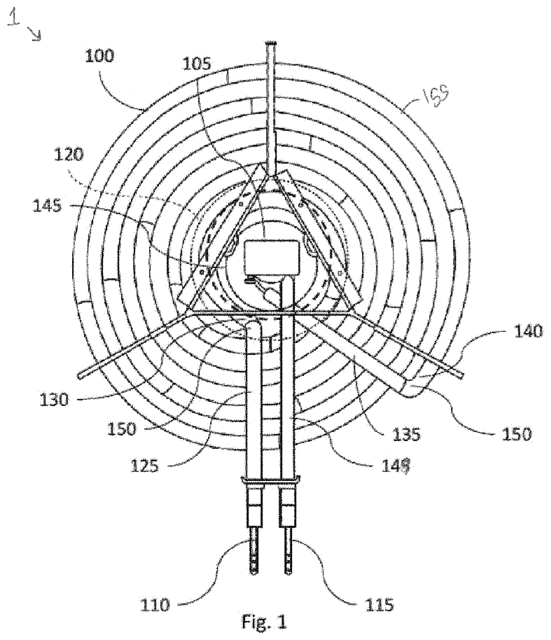

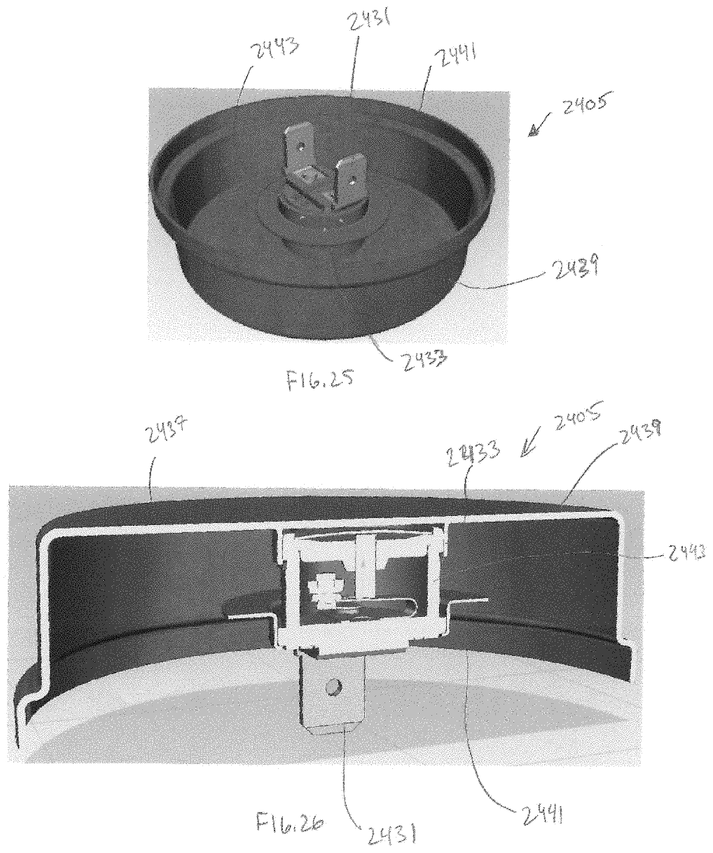

FIGS. 1-26 illustrate various examples of a heater 1, 901, 1301, 1401, 1801, 2101, 2401 consistent with implementations of the current subject matter. The features, properties, and/or components of each of the heaters 1, 901, 1301, 1401, 1801, 2101, 2401 described herein may be implemented on one or more of the other disclosed heaters 1, 901, 1301, 1401, 1801, 2101, 2401 and/or interchanged with one or more of the features, properties, and/or components of each of the heaters 1, 901, 1301, 1401, 1801, 2101, 2401. For example, the features, properties, and/or components of the heater 1 may be implemented in the heater 901, 1301, 1401, 1801, 2101, and/or 2401, and/or interchanged with one or more of the features, properties, and/or components of the heater 901, 1301, 1401, 1801, 2101, and/or 2401. The features, properties, and/or components of the heater 901 may be implemented in the heater 1, 1301, 1401, 1801, 2101, and/or 2401 and/or interchanged with one or more of the features, properties, and/or components of the heater 1, 1301, 1401, 1801, 2101, and/or 2401. The features, properties, and/or components of the heater 1301 may be implemented in the heater 1, 901, 1401, 1801, 2101, and/or 2401 and/or interchanged with one or more of the features, properties, and/or components of the heater 1, 901, 1401, 1801, 2101, and/or 2401. The features, properties, and/or components of the heater 1401 may be implemented in the heater 1, 901, 1301, 1801, 2101, and/or 2401 and/or interchanged with one or more of the features, properties, and/or components of the heater 1, 901, 1301, 1801, 2101, and/or 2401. The features, properties, and/or components of the heater 1801 may be implemented in the heater 1, 901, 1301, 1401, 2101, and/or 2401 and/or interchanged with one or more of the features, properties, and/or components of the heater 1, 901, 1301, 1401, 2101, and/or 2401. The features, properties, and/or components of the heater 2101 may be implemented in the heater 1, 901, 1301, 1401, 1801, and/or 2401 and/or interchanged with one or more of the features, properties, and/or components of the heater 1, 901, 1301, 1401, 1801, and/or 2401. The features, properties, and/or components of the heater 2401 may be implemented in the heater 1, 901, 1301, 1401, 1801, and/or 2101 and/or interchanged with one or more of the features, properties, and/or components of the heater 1, 901, 1301, 1401, 1801, and/or 2101.

FIG. 1 is a diagram illustrating a simplified bottom view of an example heater 1. The heater 1 may include a heating element 100 and thermostat 105 consistent with implementations of the current subject matter. A heating element 100 may be operatively connected between a first terminal 110 and a second terminal 115 coupled to the heating element 100 to conduct a current through the heating element 100. The first terminal 110 and the second terminal 115 may be connected across a voltage source or other power supply (not shown) that provides the current for the heating element 100.

The heating element 100 may be generally shaped in a spiral configuration with current flowing from the first terminal 110 to at least a portion of the heating element 100, such as a surface heating portion 155, and then spiraling radially outwardly through the heating element 100 to return through the second terminal 115. For example, the heating element 100 may include one or more coil turns (e.g., one, two, three, four, five or more coil turns) 159. Though the implementations shown herein illustrate a spiral pattern to the heating element 100, other structural forms of the heating element 100 may be used. For example, the heating element 100 may be rectangular, grid shaped, triangular, or the like. The heating element 100 may be constructed of any electrically conducting material, for example, iron, steel, tungsten, or the like. The cross-sectional shape of the heating element 100, as shown in FIG. 1, may be circular. However, other cross-sectional shapes are possible, including rectangular, square, semi-circular, and/or the like.

The heating element 100 may be shaped to provide a generally planar surface such that the object to be heated may be placed onto the heating element 100 in a generally level orientation. However, the heating element 100 may also be shaped in other ways, for example, to form a concave or convex surface, to provide an angle between two portions of the surface of the heating element 100, and/or the like.

In some implementations, the thermostat 105 is positioned within a region (e.g., a central region) 120 of the heating element 100 and operatively connected in series between the first terminal 110 and the second terminal 115. The thermostat 105 may measure, regulate, and/or limit a temperature of the heating element 100. The thermostat 105 may include a temperature sensor. The temperature sensor may be in direct contact with the heating element 100 and/or the object placed on the heating element 100 to provide a direct measurement of the temperature of the heating element 100 and/or the object. The thermostat 105 may be thermally isolated or insulated from other heat sources such that other heat sources provide little or no contribution to the measurement by the thermostat 105. For example, when a cooler object is placed in contact with the heating element 100, the heating element 100 and the cooler object may have different temperatures. However, the isolated thermostat 105, by virtue of being in direct contact with only the object, measures the instantaneous temperature of the object.

In other implementations, the thermostat 105 may measure and regulate the times or amount of current going through the heating element 100 based on a measurement of an object in contact with the thermostat 105 and resting on the heating element 100.

The thermostat 105 may also include or be coupled to a switch configured to prevent or limit current from conducting through the heating element 100 when the thermostat 105 measures a temperature of the object that is equal to or greater than a temperature limit (e.g., a temperature threshold) and/or allow current to be supplied to the heating element 100 when the thermostat 105 measures a temperature of the object that is less than the temperature limit. Therefore, the switch may act to prevent an overheat condition in the object placed on the heater 1. When the temperature limit is reached, the thermostat 105 may cause the switch to open and break the circuit preventing current from flowing through the heating element 100. Similarly, the switch may be further configured to close and allow the current to conduct through the heating element 100 when the temperature measured by the thermostat 105 is below the temperature limit. In this way, the switch may open and close to regulate the temperature of the heating element 100 and keep the heating element 100 from attaining a temperature that meets or exceeds the temperature limit.

The opening or closing of the switch may be controlled by a control system, for example by converting the electrical measurement signals from a temperature sensor in the thermostat 105 to a temperature and comparing this temperature to the temperature limit. The control system may include at least one memory for storing instructions and a processor for performing one or more operations, such as controlling the opening or closing of the switch, regulating the temperature of the heating element 100, and/or the like. Temperature sensors may include, for example, a thermocouple, thermometer, optical sensor, or the like. The control system (e.g., computer, a chip, or other integrated circuit), may be included in the thermostat 105, or may be at an external location.

In some implementations, the opening or closing of the switch may be based on a mechanical configuration of the switch responding to changes in the temperature of the heating element 100. For example, a switch in thermal contact with the heating element 100 may move, deflect, or the like due to thermal expansion or contraction of the materials in the switch. In other implementations, the switch may be located outside the thermostat 105. For example, the switch may be at the power supply for the heating element 100, elsewhere in the heater 1 containing the heating element 100, or the like.

As noted above, the thermostat 105 may be positioned within a region 120 (e.g., a central region) of the heating element 100. The region 120 of the heating element 100 is shown by the dashed line in FIG. 1. The region 120 is not restricted to literally the illustrated boundary. The region 120 is intended to illustrate the region of the heating element 100 generally at the center of the heating element 100 and proximate to the thermostat 105. Here, the thermostat 105 is connected to the heating element 100 at a location along the heating element 100 that is substantially closer to the second terminal 115 than to the first terminal 110. The region 120 may not contain the surface heating portion 155 of the heating element 100.

Additional conductors (also referred to herein as heaters) may be connected between the terminals and the ends of the heating element 100. These conductors may act as extensions of the heating element 100 to allow connection with other components, for example, the terminals, thermostat 105, or the like. The heating element 100 may include a first or inner end conductor 125 operatively connected to conduct the current between the first terminal 110 and an inner end 130 of the heating element 100. There may also be a second or outer end conductor 135 operatively connected to conduct the current between an outer end 140 of the heating element 100 and the thermostat 105. The inner end 130 of the heating element 100 may be the location along the heating element 100 that is closest to the center of the heating element 100. Similarly, the outer end 140 of the heating element 100 may be located along the spiral-shaped heating element 100 that is the most radially distant from the center of the spiral-shaped heating element 100. The heating element 100 may also include a third conductor or second outer end conductor 149 connecting the thermostat 105 to the second terminal 115.

The inner end conductor 125 and the outer end conductor 135 may be shaped to allow connection of the heating element 100 to the first terminal 110 and the second terminal 115 below, at the same level as, and/or above the heating element 100. As described above, the heating element 100 may form a generally planar surface. The inner end conductor 125 may include a vertical portion 150 that extends below the heating element 100 to allow connection between the inner end 130 of the heating element 100 and the first terminal 110. The vertical portion 150 may be connected to a horizontal portion that extends to the first terminal 110. Similarly, the first outer end conductor 135 and the second outer end conductor 149 may also include one or more vertical portions and horizontal portions to connect the heating element 100, the thermostat 105, and the second terminal 115. Though described as including vertical and horizontal portions, the current subject matter contemplates any general shaping of the heating element 100, any inner end conductor 125, and any outer end conductor 135 to facilitate connection between the terminals, the thermostat 105, and the heating element 100.

In some implementations, the heater 1 includes a medallion 145 that is mounted in the region 120 of the heating element 100 and is in thermal contact with the thermostat 105. The medallion 145 may be a plate that occupies part of the region 120 of the heating element 100. The medallion 145 may be substantially coplanar with the top surface of the heating element 100. In other implementations, the medallion 145 may be slightly above the top surface of the heating element 100 or slightly below the top surface of the heating element 100. In some implementations, the medallion 145 may be constructed of metal, or other suitable thermally conductive material. When in thermal contact with the thermostat 105, the temperature sensor in the thermostat 105 may additionally measure the temperature of the medallion 145.

As shown, the heating element 100 may be shaped to form a top surface 155 upon which an object (not shown), for example a pot, cup, pan, or the like, may be placed for heating (this portion of the heating element 100 is also referred to herein as the surface heating portion 155).

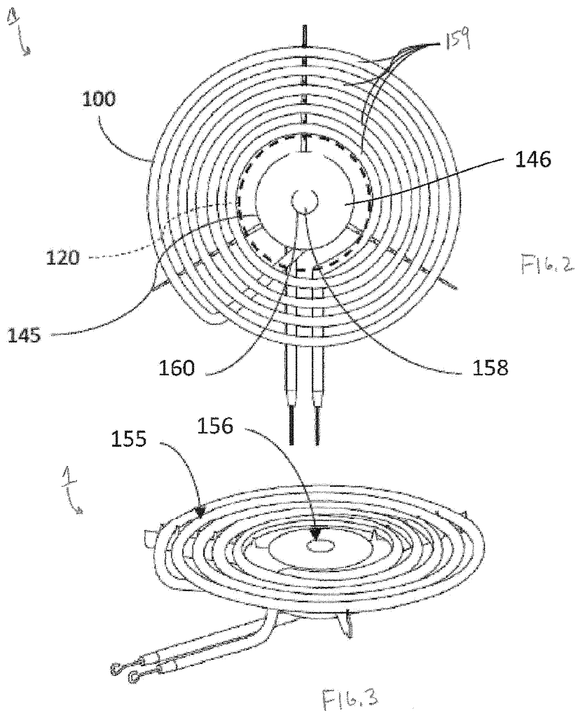

FIG. 2 is a diagram illustrating a simplified perspective view of the thermostat 105 incorporating a contact surface 156 extending through a medallion 145 consistent with implementations of the current subject matter.

For example, the thermostat 105 may include a contact surface 156 or temperature sensing portion. The contact surface 156 may be disposed to make physical contact with an object placed on the surface heating portion 155. In some implementations, the contact surface 156 may be the direct point of measurement for the temperature sensor 158 of the thermostat 105. For example, when the temperature sensor 158 is a thermocouple, the contact surface 156 may include the joint made by the two different metal types of the thermocouple. In other implementations, the contact surface 156 may include another metal surface or similar material portion of sufficiently small thickness and thermal conductivity such that the point of measurement for the temperature sensor 158 essentially measures the same temperature as the object on the other side of the contact surface 156. For example, the thermostat 105 may include a contact plate or other protective surface or shell surrounding the temperature sensor 158 while not interfering with the measurement of the temperature of the object by the temperature sensor 158.

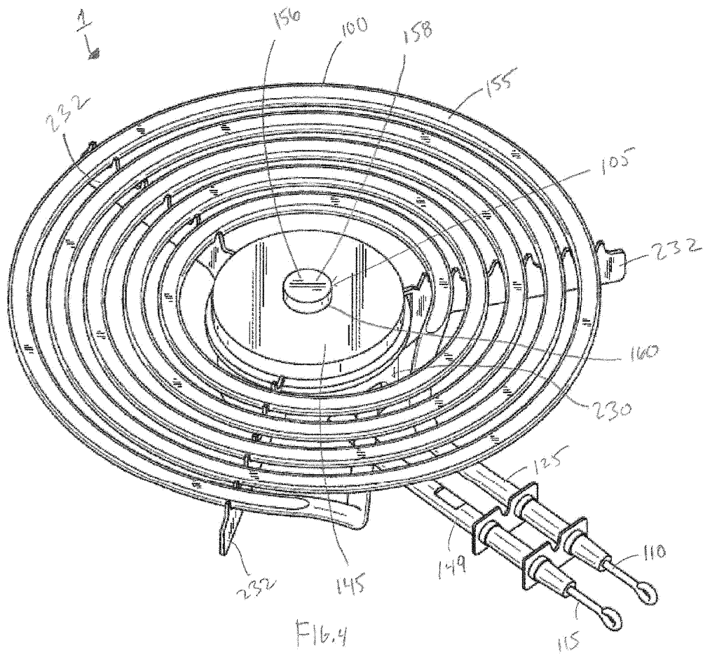

Referring to FIG. 2 and FIG. 3, the medallion 145 may be positioned below the top surface 155 of the surface heating element 100. The medallion 145 may include a top surface 146 that may provide support for the object.

In some implementations, the medallion 145 includes a medallion aperture 160 shaped to allow the contact surface 156 to extend vertically through the medallion aperture 160 to make physical contact with the object. The medallion aperture 160 may be a circular hole through the medallion 145 and may be slightly larger in diameter than the temperature sensor 158 (and possibly the corresponding contact surface 156). The shape of the medallion 145 and the medallion aperture 160, may be, for example, circular, square, hexagonal, or the like.

In some implementations, the top surface 146 of the medallion 145 may be flush or coplanar with the top surface 155 of the heating element 100. In other implementations, the top surface 146 of the medallion 145 may be slightly above the top surface 155 or slightly below the top surface 155 of the heating element 100. For example, the distance between top surface 146 of the medallion 145 and the top surface 155 of the heating element 100 may be approximately 0 mm (i.e. coplanar), +0.2 mm, +0.4 mm, +0.6 mm, +0.8 mm, +1.0 mm, +2.0 mm, +3.0 mm, less than +5.0 mm, less than 1.0 cm, etc. Similarly, the medallion 145 distance below the top surface 155 may be, for example, approximately −0.2 mm, −0.4 mm, −0.6 mm, −0.8 mm, −1.0 mm, −2.0 mm, −3.0 mm, less than −5.0 mm, greater than −1.0 cm, etc.

To provide enhanced thermal contact with the object, the temperature sensor 158 (or equivalent contact surface 156 for the thermostat 105) may extend vertically above the top surface 146 of the medallion 145 and/or the surface heating portion 155 of the heating element 100. In some implementations, the contact surface 156 may extend vertically approximately 0.2 mm above the medallion 145. For example, a pot with a flat bottom surface may be placed on the heating element 100. Because, in this implementation, the contact surface 156 extends above the medallion 145 (and the surface heating portion 155 of the heating element 100) direct physical contact with the object is ensured. Direct physical contact, as opposed to providing an air gap, may improve the accuracy of the temperature measurement and the response times for detection of changes in the temperature of the object. However, in other implementations, an air gap may be incorporated to provide other benefits.

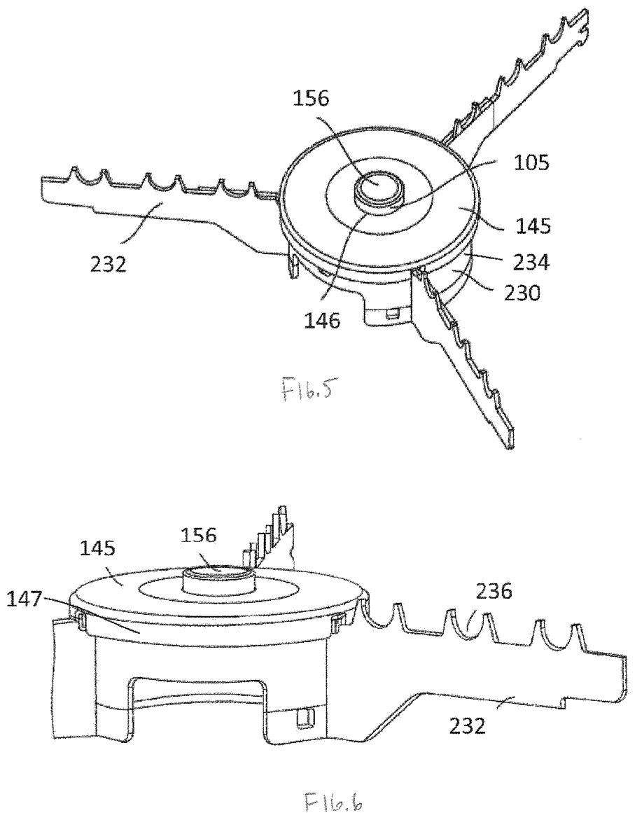

Referring to FIG. 4 and FIG. 5, the heater 1 may include a housing 230 and one or more (e.g., one, two, three, four, or more) extensions 232. The medallion 145 may be coupled to the housing 230. The one or more extensions 232 for may support the heating element 100 and/or any object placed on the heating element 100. In some implementations, the one or more extensions 232 may be separately attached to the housing 230 or may comprise a single piece of material along with the housing 230. The housing 230 may also include one or more side walls 234 (see FIG. 5) that extend from the medallion 145 and/or an opening in the housing 230 to further enclose a volume inside the housing 230. The housing 230 may also include a bottom surface to substantially enclose an interior of the housing 230. The housing 230 may surround at least a portion of the thermostat 105.

FIG. 6 illustrates a close-up simplified perspective view of the housing 230 including the contact surface 156 extending through the medallion 145, consistent with certain implementations of the current subject matter. The housing 230 may allow at least vertical movement of one or more of the thermostat 105 and the medallion 145. For example, when an object is placed on the heating element 100, the thermostat 105 and/or medallion 145 may depress and move vertically downward with the weight of the object (e.g., a pot) while the contact surface 156 maintains contact with a contact surface of the object. In some implementations, the amount of movement may depend on a bracket (e.g., a spring or urging element (not shown)) coupled to the housing 230, the thermostat 105, and/or the medallion 145. In some implementations, the bracket may provide an upward force when the bracket is coupled with the housing 230. The upward force may be provided by the bracket in response to a downward force applied from the object to the thermostat 105 and/or medallion 145.

FIG. 7 is a diagram illustrating a bottom view of the housing 230 open to show the thermostat 105 consistent with certain implementations of the present disclosure. As shown in FIG. 7, the heater 1 may include an urging element 250. The urging element 250 may be coupled to the thermostat 105 (directly or indirectly via another component) and located within the housing 230. The urging element 250 may be located at least partially within, and/or coupled to, the medallion 145. In some implementations, the medallion 145 may be coupled to any portion or connection point of the urging element 250, such as a top surface of the urging element 250.

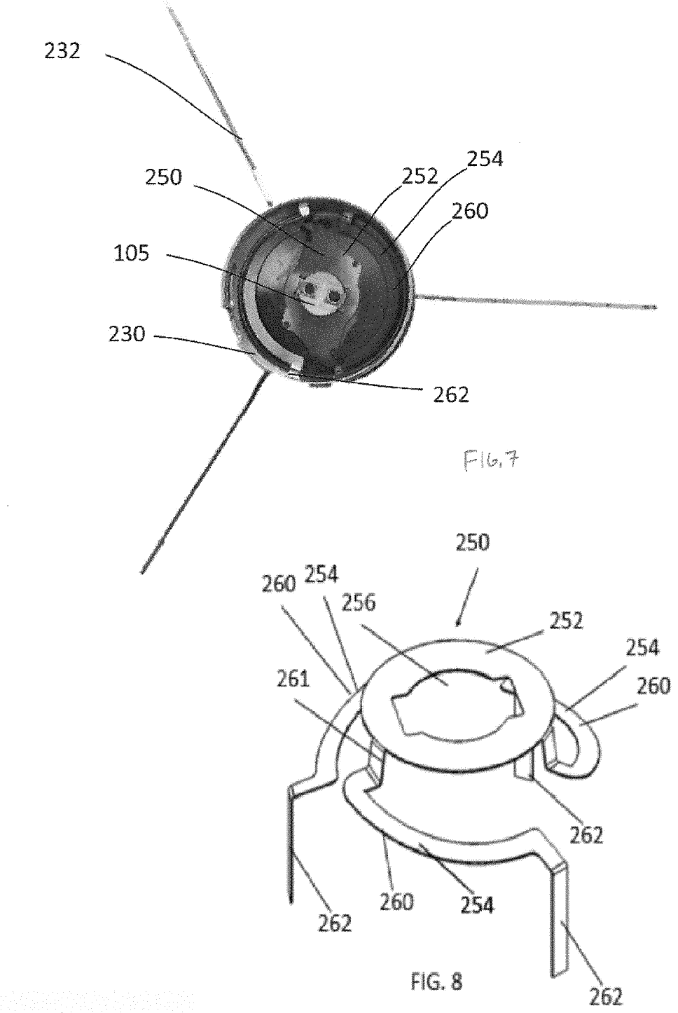

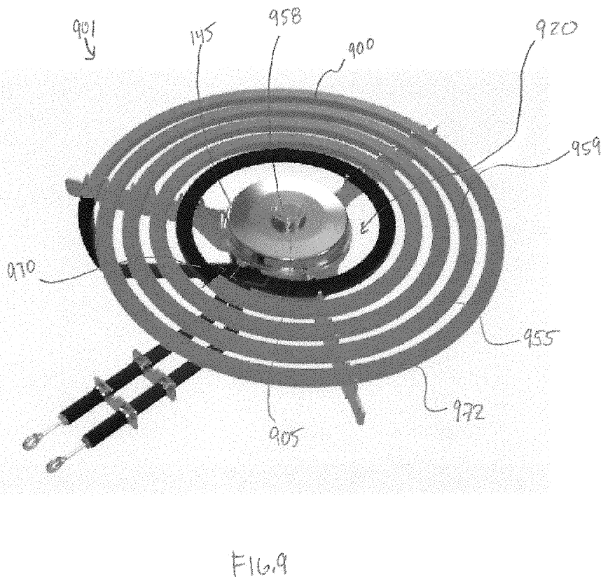

FIG. 8 illustrates an example of the urging element 250, consistent with implementations of the current subject matter. The urging element 250 may define a biasing member, a spring, a bracket, or another mechanism producing a spring effect to allow or absorb vertical, horizontal, and/or radial movements of the thermostat 105 and/or the medallion 145. For example, the urging element 250 may produce a springing effect to allow vertical, horizontal, and/or radial movements of the thermostat 105 when an object is placed in contact with the contact surface 156, when the object is placed on the heating element 100, and/or when the object is moved along the contact surface 156. The urging element 250 may encourage movement of the thermostat 105 is a single direction (e.g., a vertical direction) when the object is placed in contact with the contact surface 156 (or on the heating element 100) and/or when an object is moved along the contact surface 156 (or along the heating element 100). The urging element 250 may also limit the extent to which the thermostat moves vertically, horizontally, and/or radially when an object is placed in contact with the contact surface 156 (or on the heating element 100) or when an object is moved along the contact surface 156 (or along the heating element 100).

Referring again to FIG. 7 and FIG. 8, the urging element 250 may be shaped and/or sized to support the thermostat 105 and/or the medallion 145. For example, the urging element 250 may comprise a platform 252 and one or more legs 254 extending from the platform 252. The example urging element 250 shown in FIG. 7 and FIG. 8 includes two legs 254. However, the urging element 250 may include three, four, or more legs 254.

The platform 252 of the urging element 250 is configured to be coupled with a bottom surface of the medallion 145 and/or a portion of the thermostat 105. The platform 252 is configured to support the medallion 145, the thermostat 105, and/or at least a portion of the heating element 100. The urging element 250 provides an upward force on the medallion 145 and/or thermostat 105. For example, the platform 252 forms a flat surface upon which the medallion 145 rests, allowing the medallion to move vertically, horizontally, and/or radially with the platform 252 when an object is positioned on the heating element 100. The platform 252 may be welded, mechanically fastened, or otherwise adhered to the bottom surface of the medallion 145.

When the platform 252 of the urging element 250 is coupled with the medallion 145, at least a portion of the urging element 250 may reside within at least a portion of the medallion 145. For example, the medallion 145 may include one or more side walls 147 that extend downwardly from a top surface of the medallion 145 and surround at least a portion of the urging element 250, such as the platform 252 (see FIG. 6 and FIG. 7). In some implementations, the medallion 145 and/or the one or more side walls 147 may include a slot configured to allow vertical movement the medallion 145 with respect to the housing 230 when an object is placed on or removed from the contact surface 156, the medallion 145, and/or the heating element 100.

The platform 252 may include a bracket aperture 256. The bracket aperture 256 is configured to be of a similar size and shape as the thermostat 105 to allow passage through the bracket aperture 256. In other implementations, the bracket aperture 256 may comprise other shapes and sizes that allow the thermostat 105 to extend through the bracket aperture 256. In some implementations, the bracket aperture 256 aligns (e.g., concentrically) with the medallion aperture 160 when assembled, to allow the thermostat 105 to pass through.

The urging element 250 also includes one or more legs 254 extending from the platform 252. The urging element 250 may include one, two, three, four or more legs 254 that extend outwardly away from and/or radially about the platform 252. For example, the legs 254 include an extension portion 260 and a coupling portion 262. The extension portion 260 forms an upper portion of the legs 254 and extends outwardly and/or radially away from the platform 252, such as in a spiral shape. The coupling portion 262 extends from the extension portion 260 and forms a lower portion of the legs 254. In some implementations, the extension portion 260 is coupled directly to the platform 252. In some implementations, the legs 254 each include a spacing portion 261 that couples the platform 252 to the extension portion 260. The spacing portion 261 may extend at an angle away from the platform 252 to the extension portion 260.

The urging element 250 shown in FIG. 8 includes two legs 254. The extension portion 260 of the each of the two legs 254 extends radially about the platform 252 in the same direction (e.g., the extension portion of each of the legs extends in a clockwise direction about a center of the platform 252 when viewed from the top).

When the urging element 250 is in a neutral position, in which external forces are not applied to the urging element 250, the extension portions 260 may be approximately co-planar with the platform 252. In the neutral position, the extension portions 260 define at least a part of a circumference of a circular shape formed about the platform 252.

When the urging element 250 is in the neutral position, in which external forces are not applied to the urging element 250, the coupling portion 262 of the legs 254 may extend on an angle downwardly away from the extension portion 260 of the legs 254. For example, the coupling portion 262 may extend from the extension portion 260 beginning at a bend formed in the legs 254. The bend may be formed at one end of the extension portion 260 away from the platform 252. Thus, the urging element 250 may include a plurality of planar sections defined by the various portions of the legs 254 (e.g., the spacing portion 261, the extension portion 260, and/or the coupling portion 262). One or more of the plurality of planar sections may be connected at an angle. The vertical movement of the urging element 250 may be caused by a restorative force to restore the angle between two or more of the plurality of planar sections.

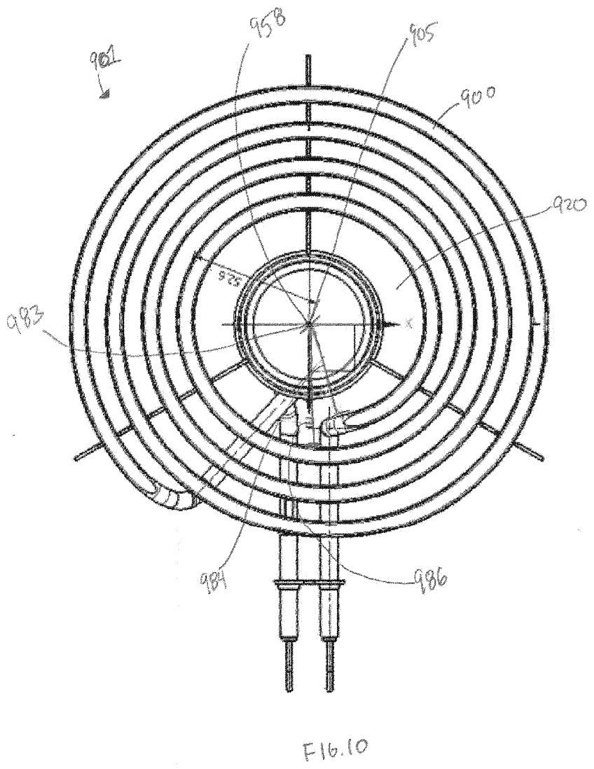

FIGS. 9-12 illustrates a heater 901 consistent with implementations of the current subject matter. The heater 901 includes a heating element 900 and a temperature sensor 958. In some implementations, the heater 901 also includes a switch, an urging element, such as the urging element 250, and/or a medallion, such as the medallion 145, consistent with implementations of the current subject matter.

For example, the temperature sensor 958 and/or the switch may be electrically coupled to at least a portion of the heating element 900. The switch that may open and close to regulate the temperature of the heating element 900 and keep the heating element 900 from attaining a temperature that meets or exceeds the temperature limit. In other words, the switch may prevent a current from conducting through the heating element 900, such as to a surface heating portion 955 of the heating element, when the temperature sensor 958 measures a temperature equal to or greater than a temperature threshold. Additionally and/or alternatively, the switch may allow the current to be supplied to the heating element 900, such as the surface heating portion 955, when the temperature sensor 958 measures a temperature less than the temperature threshold. As a result, during operation of the heating element 900, such as when the heating element 900 is heating an object placed on the heating element 900, such as on the surface heating portion 955 of the heating element 900, the temperature sensor 958 may measure a temperature of the object, and depending on the measured temperature, the switch may open and/or close one or more times to regulate the temperature of the heating element 900.

In some implementations, the temperature sensor 958 and/or the switch forms at least a portion of a thermostat 905. In other implementations, the temperature sensor 958 and/or the switch alone defines the thermostat 905. Thus, the heater 901 may include the thermostat 905, which may be electrically coupled to at least a portion of the heating element 900.

As described herein, the urging element 250 may mechanically deform to provide vertical movement of at least the temperature sensor 958 in response to a downward force applied to the temperature sensor 958, such as by the object. In some implementations, the urging element 250 includes a plurality of planar sections. At least some of the plurality of planar sections may be connected at an angle. The vertical movement provided by the urging element 250 may be caused by a restorative force to restore the angle between two or more of the plurality of planar sections, such as in response to the downward force.

Referring again to FIG. 9, the heating element 900 may be in a spiral configuration. For example, the heating element 900 may include the surface heating portion 955 that extends radially and outwardly in the spiral configuration about a central region 920, which does not contain the surface heating portion 955. The spiral configuration may include one or more coil turns 959, such as four to five coil turns 959. In some implementations, the spiral configuration includes one, two, three, four, five, or more coil turns 959.

The temperature sensor 958, the switch, and/or the thermostat 905 may be positioned within the central region 920. For example, the temperature sensor 958, the switch, and/or the thermostat 905 may be positioned at a center of the central region 920, such that the one or more coil turns 959 of the heating element 900 are concentrically aligned with the temperature sensor 958, the switch, and/or the thermostat 905.

Referring to FIGS. 9-12, the heating element 900 may include an inner portion 970 and an outer portion 972. Together, the inner portion 970 and the outer portion 972 may define the surface heating portion 955 of the heating element 900. The inner portion 970 may extend, in the spiral configuration, about the central region 920. The inner portion 970 may have a first temperature during operation of the heater 901, such as when current is supplied to the heating element 900. The outer portion 972 may extend, in the spiral configuration, radially and outwardly from the inner portion. The outer portion 972 may have a second temperature during operation of the heater 901, such as when the current is supplied to the heating element 900. In some implementations, the second temperature may be higher than the first temperature. Thus, the hotter portion of the heating element 900 is positioned farther away from the temperature sensor 958, minimizing an impact of radiative heat generated by the surface heating portion 955 of the heating element 900 on the temperature sensor 958, and improving the accuracy of temperature measurements and reducing an amount of time to heat the object placed on the heating element 900.

In some implementations, the heating element 900 includes a resistive wire 974 and a sheath 976 surrounding the resistive wire 974. During operation of the heater 901, current may be supplied to the resistive wire 974 to generate heat and to heat the heating element 900, such as the surface heating portion 955 of the heating element 900.

The resistive wire 974 may include a first coil portion 978 and a second coil portion 980. The first coil portion 978 may be positioned within the inner portion 970 of the heating element 900. The second coil portion 980 may be positioned within the outer portion 972 of the heating element 900.

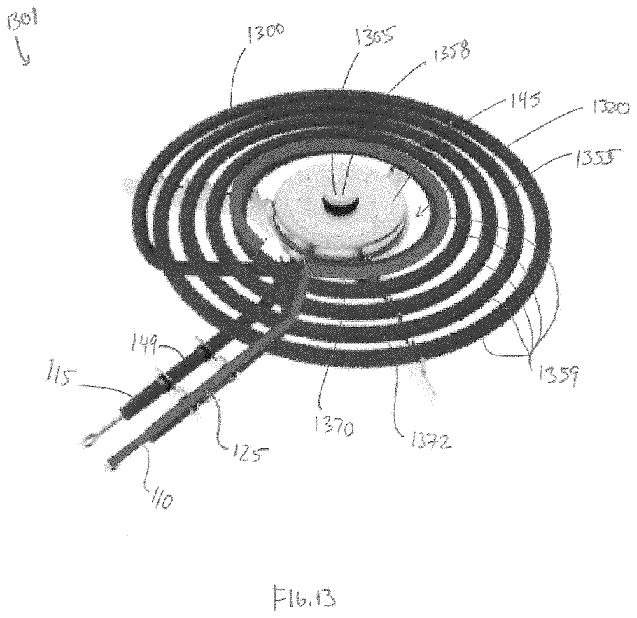

In some implementations, the first coil portion 978 is stretched relative to the second coil portion 980, thereby reducing the first temperature of the heat generated by the inner portion 970 of the heating element 900. By stretching the first coil portion 978, the first coil portion 978 of the resistive wire 974 has a reduced concentration of coils. The reduced concentration of coils reduces a temperature of the heat generated by the resistive wire 974 within the first coil portion 978, such as by conduction and/or convection. Thus, the first temperature of the stretched first coil portion 978, and as a result, the inner portion 970 of the heating element 900, is reduced or limited. For example, the resistive wire 974 may include one or more coils. Adjacent coils of the one or more coils may be spaced apart by a gap 982 (see FIG. 12). The one or more coils may also have a thickness 985, which may be constant and/or variable. In some implementations, the stretched first coil portion 978 includes a greater gap 982 between adjacent coils than in the second coil portion 980. For example, the first coil portion may include one or more first coils, each spaced apart from one another by a first gap and the second coil portion 980 may include one or more second coils, each spaced apart from one another by a second gap. The first gap may be greater than the second gap, thereby reducing the first temperature of the heat generated by the inner portion 970 of the heating element 900. In some implementations, the first gap is approximately 3.0-mm to 4.5 mm. In some implementations, the first gap is approximately 2.5 mm to 3.0 mm, 3.0 mm to 3.5 mm, 3.5 mm to 4.0 mm, 4.0 mm to 4.5 mm, or greater or other ranges therebetween. In some implementations, the second gap is approximately 1.5-2.5 mm. In some implementations, the second gap is approximately 0.5 mm to 1.0 mm, 1.0 mm to 1.5 mm, 1.5 mm to 2.0 mm, 2.0 mm to 2.5 mm, or greater or other ranges therebetween.

In some implementations, to reduce or limit the first temperature of the inner portion 970, the inner portion 970 may be coated with a coating. The coating may include an insulator, such as a ceramic coating, or other coating that provides thermal isolation.

Referring to FIG. 11, the inner portion 970 has a length of approximately 356 mm. In other implementations, the length of the inner portion 970 is approximately 300 mm to 320 mm, 320 mm to 340 mm, 340 mm to 360 mm, 360 mm to 380 mm, lesser, greater, or other ranges therebetween. In some implementations, the outer portion 972 has a length of approximately 1763 mm. In some implementations, the outer portion 972 has a length of approximately 1748 mm to 1778 mm. In other implementations, the length of the outer portion 972 is approximately 1500 mm to 1600 mm, 1600 mm to 1700 mm, 1700 mm to 1800 mm, 1800 mm to 1900 mm, lesser, greater, or other ranges therebetween.

In some implementations, a ratio of the length of the outer portion 972 to the length of the inner portion 970 is approximately 4.95:1. In some implementations, the ratio is approximately 4.9:1 to 5.0:1. In some implementations, the ratio is approximately 4.8:1 to 5.5:1. The ratio of the length of the outer portion 972 to the length of the inner portion 970 may sufficiently reduce the first temperature of the inner portion 970 to minimize the impact of the heat generated at the inner portion 970 on the temperature sensor 958.

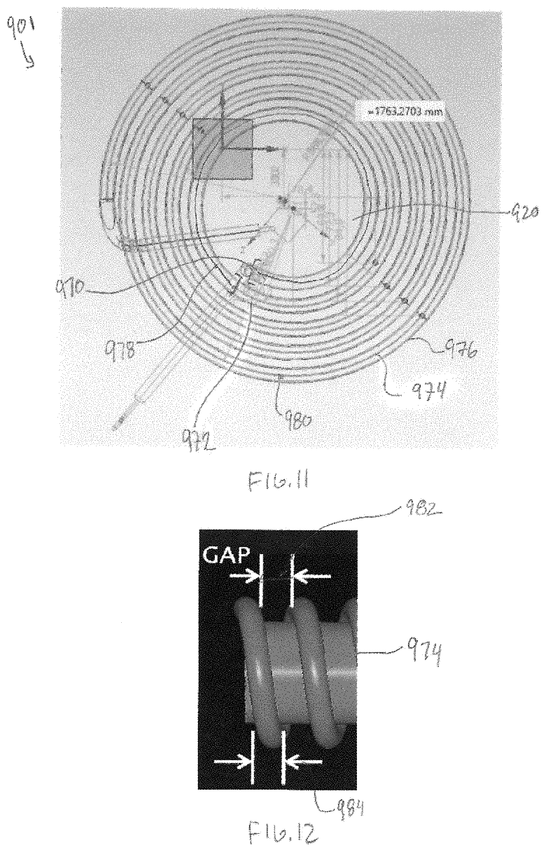

Referring to FIG. 10, a distance 984 between a center 983 of the central region 920 and an innermost portion of the inner portion 970 is approximately 52.6 mm. In some implementations, the distance 984 is approximately 50 mm to 55 mm, greater, lesser, or other ranges therebetween. In some implementations, a distance 986 between the center 983 of the central region 920 and an outermost portion of the inner portion 970 is approximately 59.7 mm. In some implementations, the distance 986 is approximately 55 mm to 65 mm, greater, lesser, or other ranges therebetween. The distance 984 and/or the distance 986 may sufficiently reduce the first temperature of the inner portion 970 to minimize the impact of the heat generated at the inner portion 970 on the temperature sensor 958.

Accordingly, the heater 901 may minimize an impact of the heat generated by the heating element 900 on the temperature sensor 958 and accurately measure a temperature of an object placed on the heating element 900, while reducing or eliminating false detection of an overheat condition. Since false detections of the overheat condition are reduced or eliminated, the switch may not improperly open and/or close during operation of the heating element 900. Thus, the heater 901 may reduce an amount of time it takes to heat the object to a desired temperature.

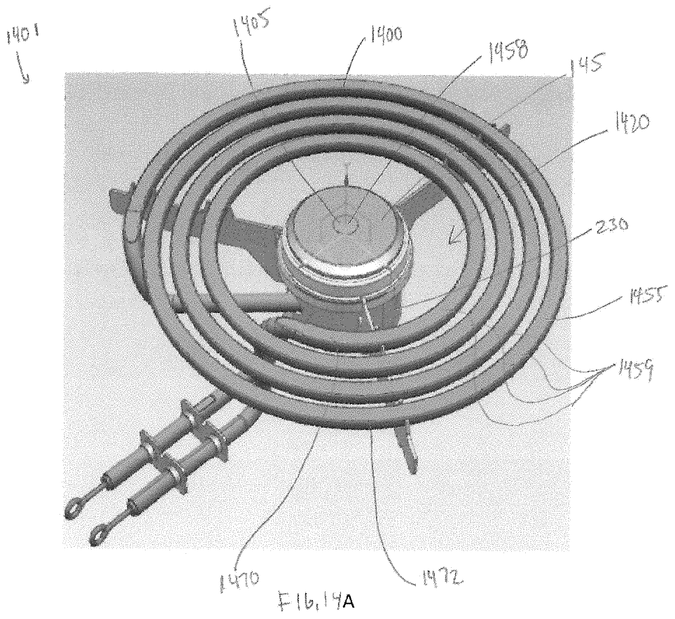

FIG. 13 illustrates a heater 1301 consistent with implementations of the current subject matter. The heater 1301 includes a heating element 1300 and a temperature sensor 1358. In some implementations, the heater 1301 also includes a switch, an urging element, such as the urging element 250, and/or a medallion, such as the medallion 145, consistent with implementations of the current subject matter.

For example, the temperature sensor 1358 and/or the switch may be electrically coupled to at least a portion of the heating element 1300. The switch that may open and close to regulate the temperature of the heating element 1300 and keep the heating element 1300 from attaining a temperature that meets or exceeds the temperature limit. In other words, the switch may prevent a current from conducting through the heating element 1300, such as to a surface heating portion 1355 of the heating element, when the temperature sensor 1358 measures a temperature equal to or greater than a temperature threshold. Additionally and/or alternatively, the switch may allow the current to be supplied to the heating element 1300, such as the surface heating portion 1355, when the temperature sensor 1358 measures a temperature less than the temperature threshold. As a result, during operation of the heating element 1300, such as when the heating element 1300 is heating an object placed on the heating element 1300, such as on the surface heating portion 1355 of the heating element 1300, the temperature sensor 1358 may measure a temperature of the object, and depending on the measured temperature, the switch may open and/or close one or more times to regulate the temperature of the heating element 1300.

In some implementations, the temperature sensor 1358 and/or the switch forms at least a portion of a thermostat 1305. In other implementations, the temperature sensor 1358 and/or the switch alone defines the thermostat 1305. Thus, the heater 1301 may include the thermostat 1305, which may be electrically coupled to at least a portion of the heating element 1300.

As described herein, the urging element 250 may mechanically deform to provide vertical movement of at least the temperature sensor 1358 in response to a downward force applied to the temperature sensor 1358, such as by the object. In some implementations, the urging element 250 includes a plurality of planar sections. At least some of the plurality of planar sections may be connected at an angle. The vertical movement provided by the urging element 250 may be caused by a restorative force to restore the angle between two or more of the plurality of planar sections, such as in response to the downward force.

Referring again to FIG. 13, the heating element 1300 may be in a spiral configuration. For example, the heating element 1300 may include the surface heating portion 1355 that extends radially and outwardly in the spiral configuration about a central region 1320, which does not contain the surface heating portion 1355. The spiral configuration may include one or more coil turns 1359, such as four to five coil turns 1359. In some implementations, the spiral configuration includes one, two, three, four, five, or more coil turns 1359.

The temperature sensor 1358, the switch, and/or the thermostat 1305 may be positioned within the central region 1320. For example, the temperature sensor 1358, the switch, and/or the thermostat 1305 may be positioned a center of the central region 1320, such that the one or more coil turns 1359 of the heating element 1300 are concentrically aligned with the temperature sensor 1358, the switch, and/or the thermostat 1305.

Referring to FIG. 13, the heating element 1300 may include an inner portion 1370 and an outer portion 1372. Together, the inner portion 1370 and the outer portion 1372 may define the surface heating portion 1355 of the heating element 1300 upon which the object is placed to be heated. The inner portion 1370 may extend, in the spiral configuration, about the central region 1320. The outer portion 1372 may extend, in the spiral configuration, radially and outwardly from the inner portion.

In some implementations, the heater 1301 includes an extended cold pin that does not generate heat. The extended cold pin may extend between a terminal of the heater 1301 and the portion of the heating element 1300 that generates heat, such as the outer portion 1372. As a result, the extended cold pin may extend around at least a portion of the central region 1320, including the temperature sensor 1358 (or thermostat 1305), thereby spacing the heat generating portion of the heating element 1300 farther away from the temperature sensor 1358, and minimizing an impact of the heat generated by the heat generating portion of the heating element 1300.

For example, the heater 1301 may additionally and/or alternatively include a first terminal, such as the first terminal 110, and a second terminal, such as the second terminal 115. The first terminal 110 and the second terminal 115 may be connected across a voltage source or other power supply (not shown) that provides the current for the heating element 1300. In other words, the first terminal 110 and the second terminal 115 may each be configured to be coupled to a power source.

In some implementations, the heater 1301 includes a first conductor, such as the inner end conductor 125. The first conductor may define a first cold pin that does not generate heat and/or generates a minimal amount of heat. The first conductor may extend between the first terminal 110 and the outer portion 1372. Thus, the first conductor defining the cold pin may include the inner portion 1370 of the heating element 1300. Such configurations of the heater 1301 may reduce an impact of radiative heat generated by the surface heating portion 1355 of the heating element 1300 on the temperature sensor 1358, thereby improving the accuracy of temperature measurements and reducing an amount of time to heat the object placed on the heating element 1300.

In some implementations, the heater 1301 additionally and/or alternatively includes a second conductor, such as the second outer end conductor 149. The second conductor may define a second cold pin that does not generate heat or generates a minimal amount of heat. The second conductor may extend between the second terminal 115 and the temperature sensor 1358 (or thermostat 1305). In some implementations, the first terminal 110, the first conductor, the thermostat 1305, the second conductor, and/or the second terminal 115 are electrically coupled in series.

Accordingly, the heater 1301 may minimize an impact of the heat generated by the heating element 1300 on the temperature sensor 1358 and accurately measure a temperature of an object placed on the heating element 1300, while reducing or eliminating false detection of an overheat condition. Since false detections of the overheat condition are reduced or eliminated, the switch may not improperly open and/or close during operation of the heating element 1300. Thus, the heater 1301 may reduce an amount of time it takes to heat the object to a desired temperature.

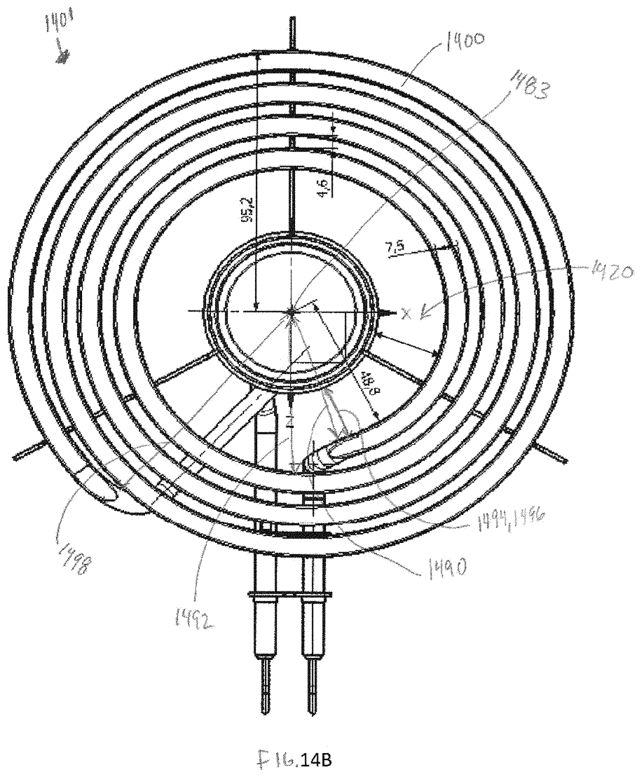

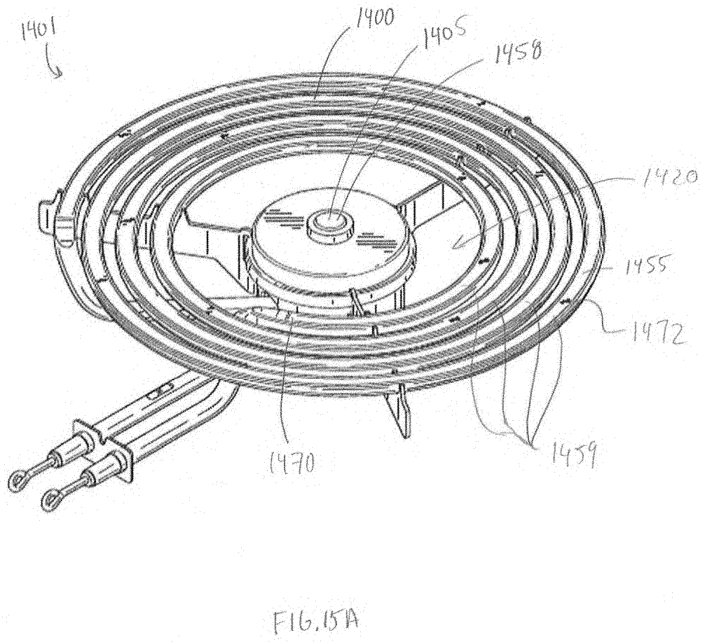

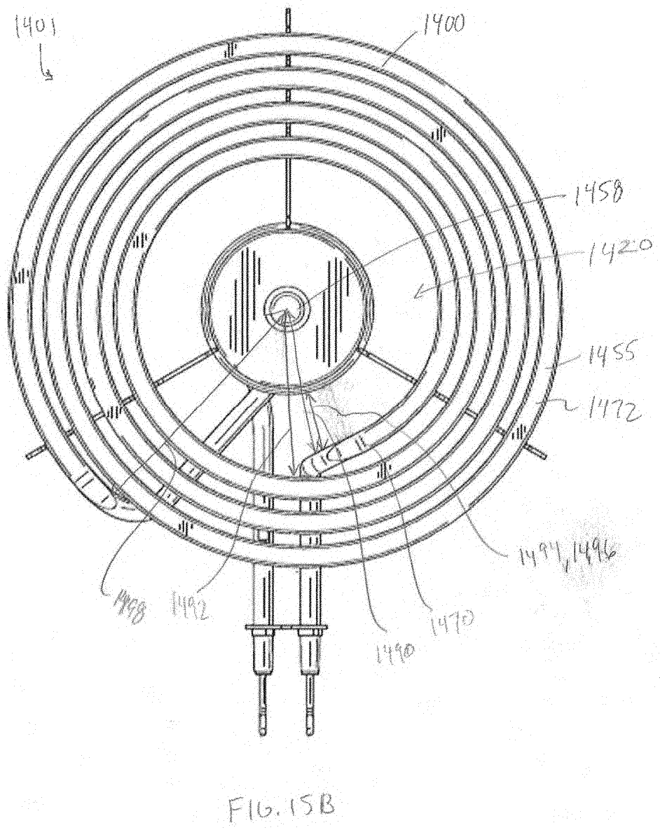

FIGS. 14A-16 illustrate a heater 1401 consistent with implementations of the current subject matter. The heater 1401 includes a heating element 1400 and a temperature sensor 1458. In some implementations, the heater 1401 also includes a switch, an urging element, such as the urging element 250, and/or a medallion, such as the medallion 145, consistent with implementations of the current subject matter. FIGS. 14A and 14B show an example of the heater 1401 with the medallion 145 (e.g., a cover) enclosing, or at least partially enclosing, the urging element 250 and/or the temperature sensor 1458 within a housing (e.g., the housing 230). FIGS. 15A and 15B show an example of the heater 1401, in which the temperature sensor 1458 may pass through the medallion 145 to contact the object positioned on the heater 1401.

For example, the temperature sensor 1458 and/or the switch may be electrically coupled to at least a portion of the heating element 1400. The switch that may open and close to regulate the temperature of the heating element 1400 and keep the heating element 1400 from attaining a temperature that meets or exceeds the temperature limit. In other words, the switch may prevent a current from conducting through the heating element 1400, such as to a surface heating portion 1455 of the heating element, when the temperature sensor 1458 measures a temperature equal to or greater than a temperature threshold. Additionally and/or alternatively, the switch may allow the current to be supplied to the heating element 1400, such as the surface heating portion 1455, when the temperature sensor 1458 measures a temperature less than the temperature threshold. As a result, during operation of the heating element 1400, such as when the heating element 1400 is heating an object placed on the heating element 1400, such as on the surface heating portion 1455 of the heating element 1400, the temperature sensor 1458 may measure a temperature of the object, and depending on the measured temperature, the switch may open and/or close one or more times to regulate the temperature of the heating element 1400.

In some implementations, the temperature sensor 1458 and/or the switch forms at least a portion of a thermostat 1405. In other implementations, the temperature sensor 1458 and/or the switch alone defines the thermostat 1405. Thus, the heater 1401 may include the thermostat 1405, which may be electrically coupled to at least a portion of the heating element 1400.

As described herein, the urging element 250 may mechanically deform to provide vertical movement of at least the temperature sensor 1458 in response to a downward force applied to the temperature sensor 1458, such as by the object. In some implementations, the urging element 250 includes a plurality of planar sections. At least some of the plurality of planar sections may be connected at an angle. The vertical movement provided by the urging element 250 may be caused by a restorative force to restore the angle between two or more of the plurality of planar sections, such as in response to the downward force.

Referring again to FIGS. 14-16, the heating element 1400 may be in a spiral configuration. For example, the heating element 1400 may include the surface heating portion 1455 that extends radially and outwardly in the spiral configuration about a central region 1420, which does not contain the surface heating portion 1455. The spiral configuration may include one or more coil turns 1459. Rather than having four to five coil turns 1459, in some implementations, the heating element 1400 includes a lesser number of coil turns, such as three to four (or less) coil turns 1459. In other implementations, the heating element 1400 includes three to five (or less) coil turns 1459. In some implementations, a coil turn is a full turn around a circumference of the central region (e.g., the central region 1420). In other implementations, a coil turn is at least a partial extension about the circumference of the central region (e.g., the central region 1420).

The temperature sensor 1458, the switch, and/or the thermostat 1405 may be positioned within the central region 1420. For example, the temperature sensor 1458, the switch, and/or the thermostat 1405 may be positioned a center of the central region 1420, such that the one or more coil turns 1459 of the heating element 1400 are concentrically aligned with the temperature sensor 1458, the switch, and/or the thermostat 1405.

Referring to FIG. 14A and FIG. 15A, the heating element 1400 may include an innermost coil turn 1470. The innermost coil turn 1470 may extend, in the spiral configuration, about the central region 1420. The innermost coil turn 1470 may define at least a part of the surface heating portion 1455, upon which the object is placed to be heated.

In some implementations, as noted above, the heating element 1400 may include a reduced number of coil turns 1459. For example, compared to the heating element 100, 900, and/or 1300, an inner coil turn may be removed. In other words, the innermost coil turn 1470 of the heating element 1400 may be spaced farther away from the temperature sensor 1458 and/or the housing 230. The central region 1420, which does not contain the surface heating portion 1455 may additionally and/or alternatively have an increased radius to space the innermost coil turn 1470 farther away from the temperature sensor 1458. As a result, the heat generating portion, such as the surface heating portion 1455, of the heating element 1400 is positioned farther away from the temperature sensor 1458, thereby minimizing an impact of the heat generated by the heat generating portion of the heating element 1400 on the temperature sensor 1458.

Referring to FIG. 14B and FIG. 15B, the central region 1420 may have a minimum radius 1490 and/or a maximum radius 1492. The minimum radius 1490 and/or the maximum radius 1492 may be optimally sized to reduce an impact of the heat generated by the heat generating portion of the heating element 1400 on the temperature sensor 1458 to reduce false detections of overheat conditions. For example, the minimum radius 1490 of the central region 1420 may be approximately 45.5 mm to 54.5 mm. In some implementations, the minimum radius 1490 of the central region 1420 is approximately 45.5 mm. In some implementations, the minimum radius 1490 of the central region 1420 is approximately 54.5 mm. In some implementations, the minimum radius 1490 of the central region 1420 is approximately 48.8 mm. In some implementations, the minimum radius 1490 of the central region 1420 is approximately 40 mm to 50 mm, 44 mm to 46 mm, 40 mm to 45 mm, 45 mm to 50 mm, 50 mm to 55 mm, 55 mm to 55 mm or greater, or other ranges therebetween. In some implementations, the maximum radius 1492 of the central region 1420 is approximately 54.5 mm. In some implementations, the maximum radius 1492 of the central region 1420 is approximately 57.6 mm to 66.6 mm. In some implementations, the maximum radius 1492 of the central region 1420 is approximately 50 mm to 55 mm, 55 mm to 60 mm, 60 mm to 65 mm, 65 mm to 70 mm, or greater, or other ranges therebetween.

Referring again to FIG. 14B and FIG. 15B, a minimum distance 1494 between a radially-outward-most surface of the medallion 145 and the innermost coil turn 1470 is approximately 16 mm to 25 mm. In some implementations, the minimum distance 1494 is approximately 15 mm to 20 mm, 20 mm to 25 mm, 25 mm to 30 mm, or greater, or other ranges therebetween. The minimum distance 1494 may help to sufficiently space the surface heating portion 1455 from the temperature sensor 1458.

In some implementations, a minimum distance 1496 between the housing 230 and the innermost coil turn 1470 is approximately 16 mm to 25 mm. In some implementations, the minimum distance 1496 is approximately 15 mm to 20 mm, 20 mm to 25 mm, 25 mm to 30 mm, or greater, or other ranges therebetween. The minimum distance 1496 may help to sufficiently space the surface heating portion 1455 from the temperature sensor 1458. The minimum distance 1494 may be the same as the minimum distance 1496 in some implementations.

In some implementations, the heating element 1400 includes an outermost coil turn 1472. The outermost coil turn 1472 may extend, in the spiral configuration, about the central region 1420 and the innermost coil turn 1470. The outermost coil turn 1472 may form at least a part of the surface heating portion 1455. For example, the outermost coil turn 1472 and the innermost coil turn 1470 may form at least a part of the surface heating portion 1455.

In some implementations, an outermost radius 1498 between a center 1483 of the central region 1420 and the outermost coil turn is approximately 95.2 mm. In some implementations, the outermost radius 1498 is approximately 87.7 mm. In some implementations, the outermost radius 1498 is approximately 87.7 mm to 95.2 mm, 75 mm to 80 mm, 80 mm to 85 mm, 85 mm to 90 mm, 90 mm to 95 mm, or greater or other ranges therebetween.

In some implementations, a ratio of the outermost radius 1498 to the minimum radius 1490 is approximately 1.6 to 2.1. Such ratio may help to sufficiently space the surface heating portion 1455 from the temperature sensor 1458.

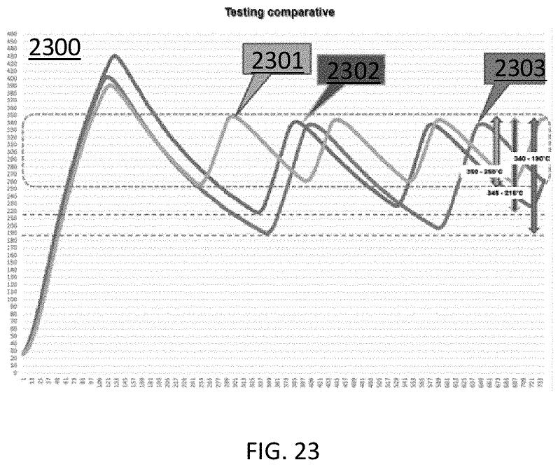

The particular configuration and/or dimensions described herein (e.g., the minimum radius of the central region, etc.) have been selected such that the surface heating portion 1455 of the heater 1301 is spaced a sufficient (e.g., at least a threshold) distance from the temperature sensor 1458. For example, the minimum radius of the central region may be selected such that the surface heating portion 1455 is spaced from the temperature sensor 1458 to limit interference with operation of the temperature sensor 1458. Accordingly, when the surface heating portion 1455 is heated to a heating temperature for heating an object positioned on the surface heating portion 1455, the heat flux (e.g., heat emitted) from the surface heating portion 1455 is sufficiently low such that it does not interfere with (and/or has a minimal, limited, and/or below-threshold impact on) the temperature sensed by the temperature sensor 1458 and/or of the object positioned on the surface heating portion 1455. As described in more detail below with respect to FIG. 23, the particular configuration of the heater 1301 described herein has been tested and has been determined to exhibit a stable and consistent temperature with reduced variance between the maximums (e.g., peaks) and minimums (e.g., valleys) of the temperature, reduce the frequency of the temperature changes between the maximums and minimums, and reduce the value of the maximums and minimums compared to conventional and other heaters, while still heating the surface heating portion of the heater 1301 to a desired temperature. The heater 1301 includes an innermost coil turn that is spaced farther away from a center of the heater 1301 than conventional heaters and/or has a reduced quantity of coil turns relative to conventional heaters. In particular, the heater 1301 has been specifically arranged to minimize and/or eliminate an impact of the heat emitted by the surface heating portion 1455 on the temperature measured by the temperature sensor 1458. For example, as noted, the minimum radius 1490 of the central region 1420 of the heater 1301 (as referred to in FIG. 23) is approximately 45.5 mm to 54.5 mm, the maximum radius 1492 of the central region 1420 of the heater 1301 is approximately 57.6 mm to 66.6 mm, the minimum distance 1494 between the radially-outward-most surface of the medallion 145 of the heater 1301 and the innermost coil turn 1470 of the heater 1301 is approximately 16 mm to 25 mm, the minimum distance 1496 between the housing 230 of the heater 1301 and the innermost coil turn 1470 of the heater 1301 is approximately 16 mm to 25 mm, and/or the outermost radius 1498 between the center 1483 of the central region 1420 of the heater 1301 and the outermost coil turn of the heater 1301 is approximately 95.2 mm. Accordingly, the particular arrangement, including one or more of the specific dimensions and/or the positioning of various components of the heater 1301 relative to one another has been determined to reduce or eliminate false detection of overheat conditions, not improperly prevent current from being supplied to the heating element of the respective heater during operation of the heating element, and/or reduce an amount of time it takes to heat the object to a desired temperature compared to conventional heaters.

Referring to FIG. 16, the heating element 1400 includes a resistive wire 1474 and a sheath 1476 surrounding the resistive wire 1474. During operation of the heater 1401, current may be supplied to the resistive wire 1474 to generate heat and to heat the heating element 1400, such as the surface heating portion 1455 of the heating element 1400. In some implementations, the surface heating portion 1455 has a length of approximately 1740 mm. In some implementations, the surface heating portion 1455 has a length of approximately 1725 mm to 1755 mm. In some implementations, the heating element 1400 includes the extended cold pin of the heater 1301.

Accordingly, the heater 1401 may minimize an impact of the heat generated by the heating element 1400 on the temperature sensor 1458 and accurately measure a temperature of an object placed on the heating element 1400, while reducing or eliminating false detection of an overheat condition. Since false detections of the overheat condition are reduced or eliminated, the switch may not improperly open and/or close during operation of the heating element 1400. Thus, the heater 1401 may reduce an amount of time it takes to heat the object to a desired temperature.

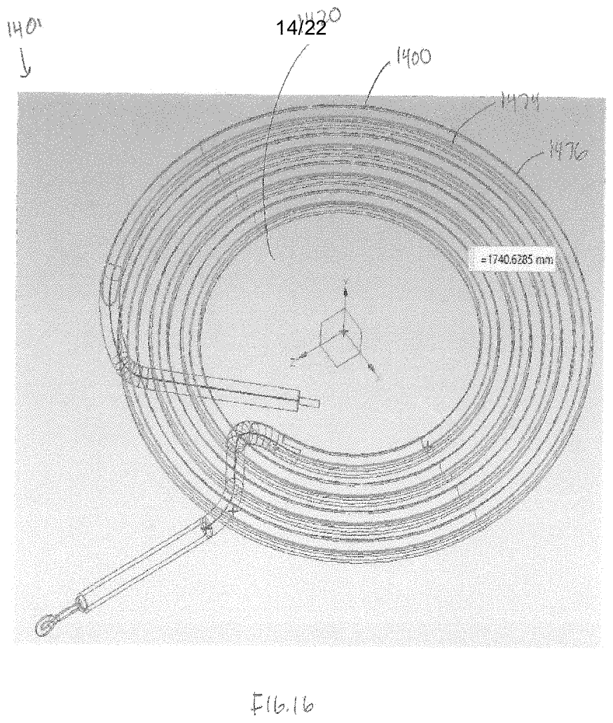

FIG. 17 illustrates a table 1700 showing results of testing heaters to determine how quickly the heaters heat an object placed on the heating element of the respective heaters. In particular, the heaters were tested to determine the amount of time required to heat 6 kilograms of water from 80° F. (26.67° C.) to 190° F. (87.7° C.). The initial temperature of the water used during the testing of each heater was 75° F. (24° C.). The water was placed in a pot on each heater. The heaters tested included the heater 1, the heater 901, the heater 1301, and the heater 1401, as described herein. The results for the heater 1 shown in the table 1701 are an average of the results across testing of five heaters 1.

As illustrated in the table 1700, the heater 901, the heater 1301, and the heater 1401 all heated the water in the object placed on the respective heating elements more quickly than the heater 1. For example, the average amount of time to heat the temperature of 6 kilograms of water from 80° F. (26.67° C.) to 190° F. (87.7° C.) for the heaters 1 was 14.78 minutes. The amount of time to heat the temperature of 6 kilograms of water from 80° F. (26.67° C.) to 190° F. (87.7° C.) for the heater 901 was 11.53 minutes, for the heater 1301 was 11.12 minutes, and for the heater 1401 was 11.85 minutes. While the average amount of downtime caused by the triggering of the switch due to a falsely detected overheat condition during the testing of heater 1 was 3.01 minutes, each of the heaters 901, 1301, 1401 experienced no downtime due to a falsely detected overheat condition. Thus, as described herein, the heaters 901, 1301, 1401 eliminated false detection of overheat conditions and resulted in faster heating times.

To further highlight the benefits of the heaters 901, 1301, 1401, as shown in table 1700, the heater 901 experienced a 22% decrease in the total time to heat the water compared to the average of the heaters 1, the heater 1301 experienced a 25% decrease in the total time to heat the water compared to the average of the heaters 1, and the heater 1401 experienced a 20% decrease in the total time to heat the water compared to the average of the heaters 1. Thus, the heaters 901, 1301, 1401 each minimized the impact of heat from the surface heating portion of the respective heating elements on the respective temperature sensors and eliminated false detection of overheat conditions and resulted in faster heating times. As a result, the heaters did not experience downtime caused by activation of the switch of the thermostat. In other words, the heaters did not experience downtime since current was continuously supplied to each of the tested heaters 901, 1301, 1401 throughout the duration of the test, without the false detection of an overheat condition.

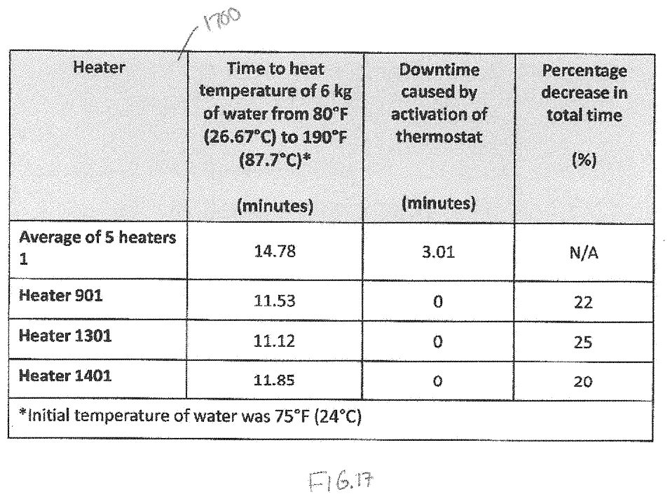

FIGS. 18-20D illustrate a heater 1801 consistent with implementations of the current subject matter. The heater 1801 includes a heating element 1800 and a temperature sensor 1858 (also referred to herein as a temperature sensing portion). In some implementations, the heater 1801 also includes a switch, an urging element, such as the urging element 250, and/or a medallion, such as the medallion 145, consistent with implementations of the current subject matter. As described in more detail below, the heater 1801 may include a heat collector 1895. The heat collector 1895 may be implemented in the heater 1801. Additionally, consistent with implementations of the current subject matter, the heat collector 1895 may be combined with any of the heaters described herein including the heater 1, the heater 901, the heater 1301, the heater 1401, the heater 1801, the heater 2101, and the heater 2401.

The temperature sensor 1858 and/or the switch may be electrically coupled to at least a portion of the heating element 1800. The switch that may open and close to regulate the temperature of the heating element 1800 and keep the heating element 1800 from attaining a temperature that meets or exceeds the temperature limit. In other words, the switch may prevent a current from conducting through the heating element 1800, such as to a surface heating portion 1855 of the heating element, when the temperature sensor 1858 measures a temperature equal to or greater than a temperature threshold. Additionally and/or alternatively, the switch may allow the current to be supplied to the heating element 1800, such as the surface heating portion 1855, when the temperature sensor 1858 measures a temperature less than the temperature threshold. As a result, during operation of the heating element 1800, such as when the heating element 1800 is heating an object placed on the heating element 1800, such as on the surface heating portion 1855 of the heating element 1800, the temperature sensor 1858 may measure a temperature of the object, and depending on the measured temperature, the switch may open and/or close one or more times to regulate the temperature of the heating element 1800.

In some implementations, the temperature sensor 1858 and/or the switch forms at least a portion of a thermostat 1805. In other implementations, the temperature sensor 1858 and/or the switch alone defines the thermostat 1805. Thus, the heater 1801 may include the thermostat 1805, which may be electrically coupled to at least a portion of the heating element 1800.

As described herein, the urging element 250 may mechanically deform to provide vertical movement of at least the temperature sensor 1858 in response to a downward force applied to the temperature sensor 1858, such as by the object. In some implementations, the urging element 250 includes a plurality of planar sections. At least some of the plurality of planar sections may be connected at an angle. The vertical movement provided by the urging element 250 may be caused by a restorative force to restore the angle between two or more of the plurality of planar sections, such as in response to the downward force.

Referring again to FIG. 18, the heating element 1800 may be in a spiral configuration. For example, the heating element 1800 may include the surface heating portion 1855 that extends radially and outwardly in the spiral configuration about a central region 1820, which does not contain the surface heating portion 1855. The spiral configuration may include one or more coil turns 1859.

The temperature sensor 1858, the switch, and/or the thermostat 1805 may be positioned within the central region 1820. For example, the temperature sensor 1858, the switch, and/or the thermostat 1805 may be positioned a center of the central region 1820, such that the one or more coil turns 1859 of the heating element 1800 are concentrically aligned with the temperature sensor 1858, the switch, and/or the thermostat 1805.

Referring to FIG. 18, the medallion 145 may include a surface, such as the top surface 146. The top surface 146 may be configured to face towards the object and/or contact the object placed on the heating element. The medallion 145 may additionally and/or alternatively include the medallion aperture 160. The medallion aperture 160, as described herein, may be shaped to allow at least the temperature sensor or temperature sensing portion 1858 of the thermostat 1805.

Referring again to FIG. 18, the heater 1801 includes a heat collector 1895. The heat collector 1895 may evenly distribute the absorbed heat throughout one or more surfaces of the heat collector 1895. Thus, even in instances when the heat collector 1895 absorbs some radiative heat from the heating element 1800, the heat collector 1895 minimizes the impact of the radiative heat by distributing the absorbed heat. Such configurations may amplify a sensing rate of the temperature sensing portion 1858 of the thermostat 1805 and provide a platform having a uniform temperature that is measured by the temperature sensing portion 1858 of the thermostat 1805, thereby improving the accuracy of the temperature measurements and reducing false detection of an overheat condition. The heat collector 1895 may include one or more materials that desirably absorb heat and distribute the absorbed heat. For example, the heat collector 1895 may include aluminum, stainless steel, and/or the like.

The heat collector 1895 may be coupled to the temperature sensing portion 1858 of the thermostat 1805. For example, the heat collector 1895 may be coupled to the temperature sensing portion 1858 via one or more of a press-fit connection, an adhesive, a screws or rivets, a thread fit, and an ultrasonic process. In some implementations, the heat collector 1895 include a coupling extension 1865 that extends from an inner surface of the heat collector 1895 that is opposite a heat collection surface 1889A (described in more detail below). The coupling extension 1865 may be coupled to one or more surfaces of the thermostat 1805, such as one or more lateral side surfaces of the thermostat 1805.

The heat collector 1895 may be coupled to the temperature sensing portion 1858 in a manner that allows the temperature sensing portion 1858 to accurately and quickly sense a temperature of the object placed on the heating element 1800. For example, the temperature sensing portion 1858 may measure indirectly measure the temperature of the object, such as by measuring a temperature of the heat collector 1895 (e.g., the heat collection portion 1889 described in more detail below), which is in thermal contact with the object.

The heat collector 1895 may extend over at least the surface 146 of the medallion and the temperature sensing portion 1858 of the thermostat 1805. As shown in FIGS. 18-20D, the heat collector 1895 may be disc shaped. For example, the shape of the heat collector 1895 may correspond to a shape of the medallion 145. It should be appreciated that the heat collector 1895 may have one or more other shapes.

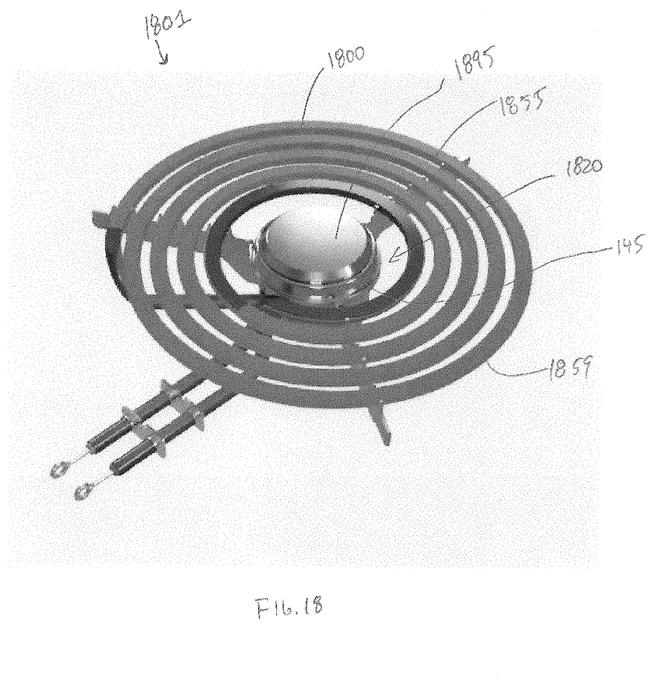

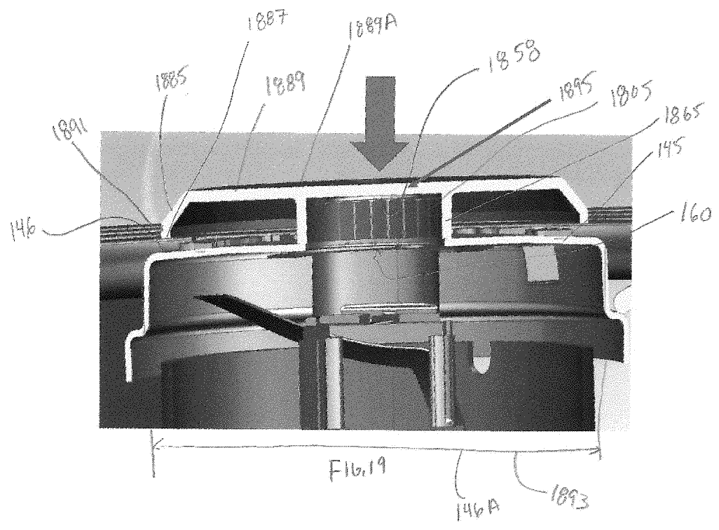

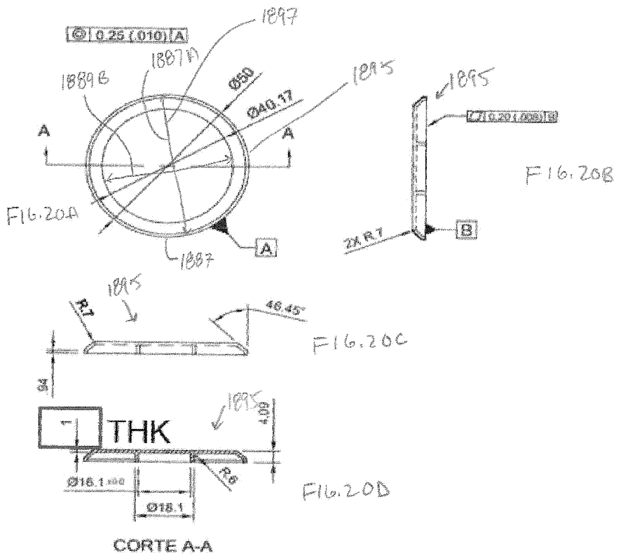

Referring to FIGS. 20A-20D, in some implementations, the heat collector 1895 extends to and/or over an outer edge of the surface 146. For example, the heat collector 1895 may have a heat collector diameter 1897 that is approximately equal to a medallion diameter 1893 (see FIG. 19) of the medallion 145. In some implementations, the heat collector 1895 has an overall height of approximately 4.09 mm. In other implementations, the height of the heat collector 1895 is approximately 4.0 to 4.1 mm, 3.5 mm to 4.5 mm, and/or the like.

Referring to FIG. 19, the heat collector 1895 may include a heat collection portion 1889, an outermost edge 1887, and/or a beveled lateral surface 1885. The heat collection portion 1889 may include a heat collection surface 1889A that is configured to contact the object placed on the hating element 1800. The heat collection surface 1889A may have a heat collection surface diameter 1889B.

The outermost edge 1887 may be an outermost edge of the heat collector 1895 that has a maximum diameter of the heat collector 1895. The outermost edge 1887 may be longitudinally aligned with an outermost edge of the surface 146 of the medallion 145. For example, the outermost edge 1887 may include a first diameter 1887A that is approximately equal to a second diameter 146A of the surface 146 of the medallion 145. In some implementations, the first diameter 1887A is equal to the heat collector diameter 1897.

The first diameter 1887A of the outermost edge 1887 may additionally and/or alternatively be greater than the heat collection surface diameter 1889B. Thus, the beveled lateral surface 1885 may be beveled and extend radially outwardly from the heat collection surface 1889A towards and/or to the outermost edge 1887. In some implementations, the heat collection surface diameter 1889B may be approximately 40 mm to 41 mm. In other implementations, the heat collection surface diameter 1889B is at least 38.2 mm. In yet other implementations, the heat collection surface diameter 1889B is at least 40 mm, 40 mm to 43 mm, 40 mm to 45 mm, 45 to 50 mm, and/or the like. In some implementations, the first diameter 1887A of the outermost edge 1887 is approximately 50 mm and/or at least 50 mm. In other implementations, the first diameter 1887A is approximately 40 mm to 45 mm, 45 to 50 mm, 50 mm to 55 mm or greater, or other ranges therebetween.

Consistent with implementations of the current subject matter, the heat collector 1895 may also include a lateral-facing surface 1891. The lateral-facing surface 1891 may include the outermost edge 1887. In other words, the outermost edge 1887 may define an edge of the lateral-facing surface 1891. In some implementations, the beveled lateral surface 1885 may extend from the heat collection surface 1889A to the lateral-facing surface 1891. The lateral-facing surface 1891 may be approximately perpendicular to the heat collection surface 1889A.

Accordingly, the heater 1801 may minimize an impact of the heat generated by the heating element 1800 on the temperature sensor 1858 and accurately measure a temperature of an object placed on the heating element 1800, while reducing or eliminating false detection of an overheat condition. Since false detections of the overheat condition are reduced or eliminated, the switch may not improperly open and/or close during operation of the heating element 1800. Thus, the heater 1801 may reduce an amount of time it takes to heat the object to a desired temperature.

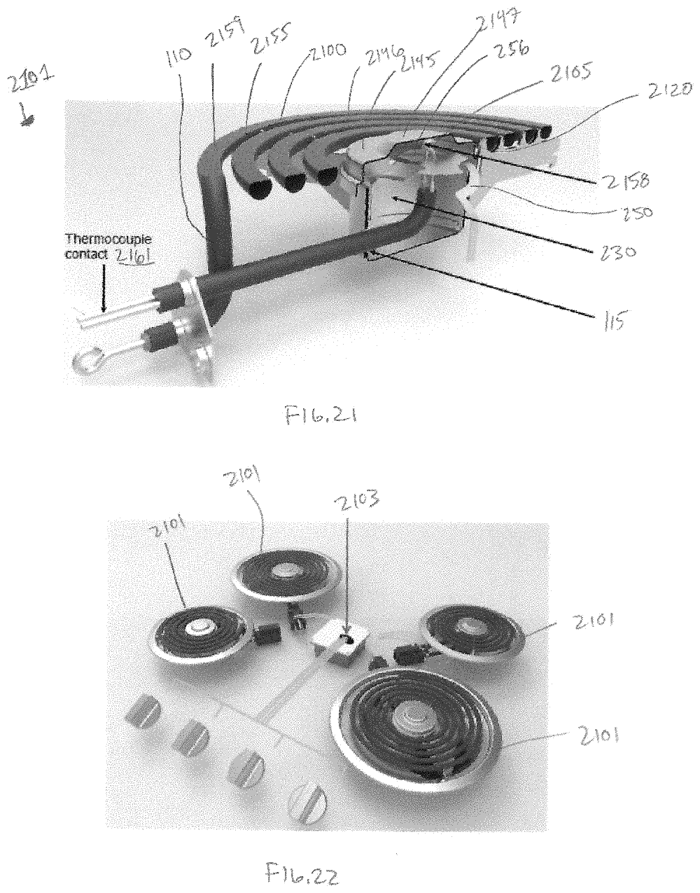

FIGS. 21-22 illustrate a heater 2101 consistent with implementations of the current subject matter. The heater 2101 includes a heating element 2100 and a thermocouple 2158. In some implementations, the heater 2101 may additionally and/or alternatively be used with a resistance temperature detector, a temperature sensor, and/or the like. In some implementations, the heater 2101 also includes a switch, an urging element, such as the urging element 250, and/or a medallion 2145 (which may be the same or similar to the medallion 145), consistent with implementations of the current subject matter. The thermocouple 2158 may quickly measure the temperature of the object, thereby improving the accuracy of temperature measurements and reducing an impact of radiative heat emitted from the heating element.

The thermocouple 2158 and/or the switch may be electrically coupled to at least a portion of the heating element 2100. The switch that may open and close to regulate the temperature of the heating element 2100 and keep the heating element 2100 from attaining a temperature that meets or exceeds the temperature limit. In other words, the switch may prevent a current from conducting through the heating element 2100, such as to a surface heating portion 2155 of the heating element, when the thermocouple 2158 measures a temperature equal to or greater than a temperature threshold. Additionally and/or alternatively, the switch may allow the current to be supplied to the heating element 2100, such as the surface heating portion 2155, when the thermocouple 2158 measures a temperature less than the temperature threshold. As a result, during operation of the heating element 2100, such as when the heating element 2100 is heating an object placed on the heating element 2100, such as on the surface heating portion 2155 of the heating element 2100, the thermocouple 2158 may measure a temperature of the object, and depending on the measured temperature, the switch may open and/or close one or more times to regulate the temperature of the heating element 2100.

In some implementations, the thermocouple 2158 and/or the switch forms at least a portion of a thermostat 2105. In other implementations, the thermocouple 2158 alone defines the thermostat 2105. Thus, the heater 2101 may include the thermostat 2105, which may be electrically coupled to at least a portion of the heating element 2100.

As described herein, the urging element 250 may mechanically deform to provide vertical movement of at least the medallion 2145 and/or the thermocouple 2158 in response to a downward force applied to the medallion 2145, such as by the object. In some implementations, the urging element 250 includes a plurality of planar sections. At least some of the plurality of planar sections may be connected at an angle. The vertical movement provided by the urging element 250 may be caused by a restorative force to restore the angle between two or more of the plurality of planar sections, such as in response to the downward force. The urging element 250 may include a central aperture 256 that allows the thermocouple 2158 to pass through the central aperture 256 and be coupled to the medallion 2145.

Referring again to FIG. 21, the heating element 2100 may be in a spiral configuration. For example, the heating element 2100 may include the surface heating portion 2155 that extends radially and outwardly in the spiral configuration about a central region 2120, which does not contain the surface heating portion 2155. The spiral configuration may include one or more coil turns 2159.

The thermocouple 2158 may be positioned within the central region 2120. For example, the thermocouple 2158 may be positioned a center of the central region 2120, such that the one or more coil turns 2159 of the heating element 2100 are concentrically aligned with the thermocouple 2158.

Referring to FIG. 21, the medallion 2145 may be positioned within the region 2120. The medallion 2145 may extend over and/or entirely cover an opening into a housing, such as the housing 230, of the heater 2101. The housing 230 may surround the thermocouple 2158 and at least a portion of a conductor and/or terminal. A connection between the heating element 2100 and the thermocouple 2158 may not be positioned within the housing 230.

As shown in FIG. 21, the thermocouple 2158 may be coupled to the medallion 2145. For example, the thermocouple 2158 may be welded to the medallion 2145 to allow the thermocouple 2158 to more accurately measure a temperature of the object placed on the heating element 2100 and in contact with the medallion 2145.

The medallion 2145 may include a surface, such as the top surface 2146. The top surface 2146 may be configured to face towards the object and/or contact the object placed on the heating element. The medallion 2145 may include a raised portion 2147. The raised portion 2147 may be raised to ensure contact between the medallion 2145 and the object placed on the heating element 2100. For example, the raised portion 2147 may be coupled to the thermocouple 2158. Thus, the raised portion 2147 may allow for the thermocouple 2158 to more accurately measure the temperature of the object in contact with the raised portion 2147. In some implementations, the raised portion 2147 is centrally located on the medallion 2145. For example, the raised portion 2147 may be centrally aligned along a longitudinal axis of the medallion 2145.

In some implementations, the heater 2101 include a thermocouple contact 2161. The thermocouple contact 2161 may extend from the thermocouple 2158. The thermocouple contact 2161 may be configured to electrically communicate with a control system 2103, which is described in more detail below. For example, via the thermocouple contact 2161, the control system 2103 may receive the temperature measurements from the thermocouple 2158.

Referring to FIG. 21, the heater 2101 may additionally and/or alternatively include a first terminal, such as the first terminal 110, and a second terminal, such as the second terminal 115. The first terminal 110 may be coupled to the surface heating portion 2155 of the heating element 2100. In other words, the first terminal 110 may be configured to supply power to the surface heating portion 2155 of the heating element 2100. The first terminal 110 may additionally and/or alternatively be coupled to the control system 2103. Thus, the control system 2103 may control the current conducting through the heating element 2100.

The second terminal 115 may be coupled to the thermocouple 2158. The second terminal 115 may include the thermocouple contact 2161. The second terminal 115 may be coupled (e.g., electrically coupled) to the control system 2103. As described herein, the thermocouple contact 2161 and/or the second terminal 115 may be configured to electrically communicate with a control system 2103, which is described in more detail below. For example, via the thermocouple contact 2161 and/or the second terminal 115, the control system 2103 may receive the temperature measurements from the thermocouple 2158.

In some implementations, the first terminal 110 and the second terminal 115 are not electrically coupled to one another when the heater 2101 is disconnected from and/or is otherwise not connected to the control system 2103. For example, the first terminal 110 and the second terminal 115 may not be electrically coupled in series when the heater 2101 is disconnected from and/or is otherwise not connected to the control system 2103. In some implementations, the first terminal 110 and the second terminal 115 are electrically coupled in series when the heater 2101 is connected to the control system 2103. In some implementations, the first terminal 110, the second terminal 115, and the control system 2103 are electrically coupled in series when the heater 2101 is connected to the control system 2103.

Referring to FIG. 22, the heater 2101 (or one or more of the heaters described herein) may be coupled to the control system 2103. In some implementations, a plurality of heaters may be coupled to the control system 2103. The control system 2103 may include at least one data processor and at least one memory storing instructions, which when executed by the at least one data processor, result in operations for controlling the current conducting through the heating element 2100.

For example, the control system 2103 may be used with and/or in place of the switch, and the control system 2103 may receive the temperature measurements from the thermocouple 2158. In configurations in which the control system 2103 is used in placed of the switch, the control system 2103 may open and close a circuit to regulate the temperature of the heating element 2100 and keep the heating element 2100 from attaining a temperature that meets or exceeds the temperature limit. In other words, the control system 2103 may prevent a current from conducting through the heating element 2100, such as to a surface heating portion 2155 of the heating element, when the thermocouple 2158 measures a temperature equal to or greater than a temperature threshold. Additionally and/or alternatively, the control system 2103 may allow the current to be supplied to the heating element 2100, such as the surface heating portion 2155, when the thermocouple 2158 measures a temperature less than the temperature threshold.

As a result, during operation of the heating element 2100, such as when the heating element 2100 is heating an object placed on the heating element 2100, such as on the surface heating portion 2155 of the heating element 2100, the thermocouple 2158 may measure a temperature of the object, and depending on the measured temperature, the control system 2103 may open and/or close a circuit one or more times to regulate the temperature of the heating element 2100.

Accordingly, the heater 2101 may minimize an impact of the heat generated by the heating element 2100 on the thermocouple 2158 and accurately measure a temperature of an object placed on the heating element 2100, while reducing or eliminating false detection of an overheat condition. Since false detections of the overheat condition are reduced or eliminated, the control system 2103 may not improperly open and/or close a circuit during operation of the heating element 2100. Thus, the heater 2101 may reduce an amount of time it takes to heat the object to a desired temperature.

FIG. 23 is a graph 2300 illustrating the effectiveness of the heater 2101 (e.g., line 2301) and the heater 1301 (e.g., line 2302) compared to existing heaters (e.g., line 2303), consistent with implementations of the current subject matter. As shown at 2301 and 2302 in FIG. 23, the temperature measured by the thermocouple 2158 of the heater 2101 and the temperature measured by the heater 1301 is more consistent during operation of the respective heater (e.g., when current is supplied to the heating element) than the heater 2303. For example, there is less variance between the peaks and valleys of the temperature measurements. In other words, there is less of a temperature change that is more level and more consistent than in the temperature measured by the heater 2303. Further, as shown in FIG. 23, the temperature of the heater shown at line 2301 has a temperature range of approximately 250 to 350 degrees Celsius, the heater shown at line 2302 has a temperature range of approximately 215 to 315 degrees Celsius, and the heater shown at line 2303 has a temperature range of approximately 190 to 340 degrees Celsius. Additionally, the frequency of the temperature swings and the amplitude of the maximum and minimum temperatures along the lines 2301, 2302 is shorter than along line 2303. This shows that the temperature provided by heater 2101 (e.g., line 2301) and/or the heater 1301 (e.g., line 2302) is more stable than existing heaters. Thus, the graph 2300 shows that the heater 2101 (e.g., line 2301) and/or the heater 1301 (e.g., line 2302) may reduce or eliminate false detection of overheat conditions, may not improperly prevent current from being supplied to the heating element of the respective heater during operation of the heating element, and/or may reduce an amount of time it takes to heat the object to a desired temperature.

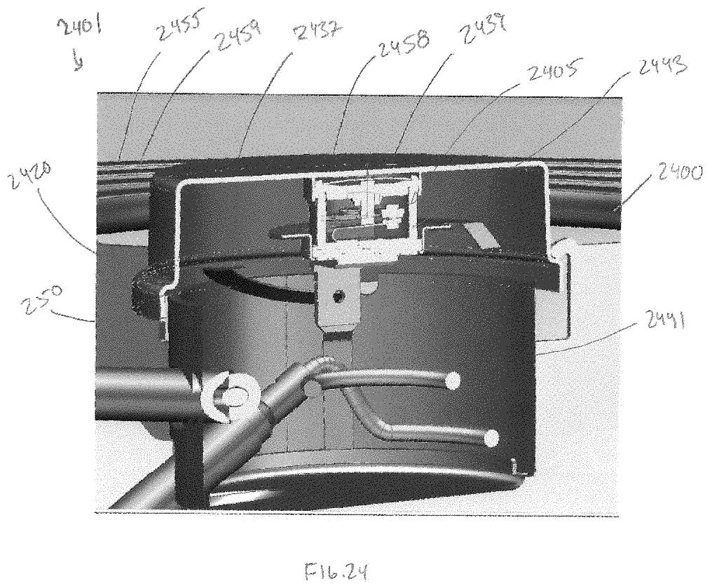

FIGS. 24-26 illustrate a heater 2401 consistent with implementations of the current subject matter. The heater 2401 includes a heating element 2400 and a thermostat 2405. In some implementations, the heater 2401 also includes a switch and/or an urging element such as the urging element 250, consistent with implementations of the current subject matter.

The thermostat 2405 may include a temperature sensor or temperature sensing portion 2458 and/or a switch. The temperature sensing portion 2458 and/or the switch may be electrically coupled to at least a portion of the heating element 2400. The switch that may open and close to regulate the temperature of the heating element 2400 and keep the heating element 2400 from attaining a temperature that meets or exceeds the temperature limit. In other words, the switch may prevent a current from conducting through the heating element 2400, such as to a surface heating portion 2455 of the heating element, when the temperature sensing portion 2458 measures a temperature equal to or greater than a temperature threshold. Additionally and/or alternatively, the switch may allow the current to be supplied to the heating element 2400, such as the surface heating portion 2455, when the temperature sensing portion 2458 measures a temperature less than the temperature threshold. As a result, during operation of the heating element 2400, such as when the heating element 2400 is heating an object placed on the heating element 2400, such as on the surface heating portion 2455 of the heating element 2400, the temperature sensing portion 2458 may measure a temperature of the object, and depending on the measured temperature, the switch may open and/or close one or more times to regulate the temperature of the heating element 2400.

In some implementations, the temperature sensing portion 2458 and/or the switch forms at least a portion of the thermostat 2405. In other implementations, the temperature sensing portion 2458 alone defines the thermostat 2405. Thus, the heater 2401 may include the thermostat 2405, which may be electrically coupled to at least a portion of the heating element 2400.

As described herein, the urging element 250 may mechanically deform to provide vertical movement of at least the thermostat 2405 in response to a downward force applied to the thermostat 2405, such as by the object. In some implementations, the urging element 250 includes a plurality of planar sections. At least some of the plurality of planar sections may be connected at an angle. The vertical movement provided by the urging element 250 may be caused by a restorative force to restore the angle between two or more of the plurality of planar sections, such as in response to the downward force.

The heating element 2400 may be in a spiral configuration. For example, the heating element 2400 may include the surface heating portion 2455 that extends radially and outwardly in the spiral configuration about a central region 2420, which does not contain the surface heating portion 2455. The spiral configuration may include one or more coil turns 2459.

The temperature sensing portion 2458 may be positioned within the central region 2420. For example, the temperature sensing portion 2458 may be positioned a center of the central region 2420, such that the one or more coil turns 2459 of the heating element 2400 are concentrically aligned with the temperature sensing portion 2458.

Referring again to FIGS. 24-26, the thermostat 2405 may include a base 2441, a thermostat body 2443, and a cap 2439. The cap 2439 and/or the base 2441 may be coupled to the thermostat body 2443 on opposite ends of the thermostat body 2443. The base 2441, the thermostat body 2443, and/or the cap 2439 may define the temperature sensing portion 2458 of the thermostat 2405.

The base 2441 may support the thermostat body 2443 and/or the cap 2439. The base 2441 may be configured to be coupled to the urging element 250. The base 2441 may thus allow the thermostat 2405 to move in response to the downward force on the thermostat and to maintain contact between the thermostat 2405 and the object placed on the heating element 2400. The base may include one or more materials, such as stainless steel. In some implementations, the thermostat body 2443 includes a ceramic material.

The cap 2439 may be configured to make physical contact with an object positioned on the surface heating portion 2455 of the heating element 2400, thereby allowing the thermostat 2405 to measure a temperature of the object placed on the heating element 2400. For example, the cap 2439 of the thermostat 2405 may measure the temperature of the object without the use of a separate medallion (e.g., the medallion described herein) or another component of the heater 2401 positioned between the thermostat and the object. The cap 2439 may include a contact surface 2437. The contact surface 2437 may be flat and may make physical contact with the object placed on the heating element 2400. The flat contact surface 2437 may maintain physical contact with the object to produce more accurate temperature measurements.

The cap 2439 may evenly distribute the absorbed heat throughout one or more surfaces of the cap 2439. Thus, even in instances when the cap 2439 absorbs some radiative heat from the heating element 2400, the cap 2439 minimizes the impact of the radiative heat by distributing the absorbed heat. Such configurations may amplify a sensing rate of the temperature sensing portion 2458 (e.g., the cap 2439) of the thermostat 2405 and provide a platform having a uniform temperature that is measured by the temperature sensing portion 2458 of the thermostat 2405, thereby improving the accuracy of the temperature measurements and reducing false detection of an overheat condition. The cap 2439 may include one or more materials that desirably absorb heat and distribute the absorbed heat. For example, the cap 2439 may include aluminum, stainless steel, and/or the like.

In some implementations, the cap 2439 may be disc shaped. For example, the shape of the cap 2439 may correspond to a shape of the opening of the housing 230. However, it should be appreciated that the cap 2439 may have one or more other shapes.

Consistent with implementations of the current subject matter, the cap 2439 may be coupled to the thermostat body 2443. For example, the cap 2439 may be coupled to the thermostat body 2443 via one or more of a press-fit connection, an adhesive, and an ultrasonic process, and/or the like. The cap 2439 may include a protrusion 2433 extending from a surface opposite the contact surface 2437. The protrusion 2433 may extend from the contact surface 2437 into an interior of the cap 2439. The protrusion 2433 may couple with the thermostat body 2443. For example, as shown in FIGS. 24-26, the protrusion 2433 may couple to at least a lateral side and/or an upper side of the thermostat body 2443. Thus, at least a portion of the thermostat body 2443 may fit within the protrusion 2433.

Consistent with implementations of the current subject matter, the heater 2401 may include the housing 230. The housing 230 in this example may house the urging element 250, at least a portion of the thermostat 2105, and/or a connection between at least one terminal of the heater 2401 and the thermostat 2405. The housing 230 may include an opening that allows the urging element 250 and/or the thermostat 2405 to move vertically in response to the downward force on the thermostat 2405. Referring to FIG. 24, the cap 2439 of the thermostat 24058 may extend over and cover the interior of the housing 230 and/or the opening into the housing 230.

In some implementations, the thermostat 2405 also includes a terminal connector 2431. The terminal connector 2431 may be coupled to the base 2441 of the thermostat 2405. The terminal connector 2431 may be coupled to a terminal of the heater 2401.

Thus, the thermostat 2405 of the heater 2401 may accurately and quickly sense a temperature of the object placed on the heating element 2400 and reduce or eliminate false detections of an overheat condition.

### Terminology

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, computer programs and/or articles depending on the desired configuration. Any methods or the logic flows depicted in the accompanying figures and/or described herein do not necessarily require the particular order shown, or sequential order, to achieve desirable results. The implementations set forth in the foregoing description do not represent all implementations consistent with the subject matter described herein. Instead, they are merely some examples consistent with implementations related to the described subject matter. Although a few variations have been described in detail above, other modifications or additions are possible. In particular, further features and/or variations can be provided in addition to those set forth herein. The implementations described above can be directed to various combinations and subcombinations of the disclosed features and/or combinations and subcombinations of further features noted above. Furthermore, above described advantages are not intended to limit the application of any issued claims to processes and structures accomplishing any or all of the advantages.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical values given herein should also be understood to include about or approximately that value, unless the context indicates otherwise. For example, if the value “10” is disclosed, then “about 10” is also disclosed. Any numerical range recited herein is intended to include all sub-ranges subsumed therein. It is also understood that when a value is disclosed that “less than or equal to” the value, “greater than or equal to the value” and possible ranges between values are also disclosed, as appropriately understood by the skilled artisan. For example, if the value “X” is disclosed the “less than or equal to X” as well as “greater than or equal to X” (e.g., where X is a numerical value) is also disclosed. It is also understood that the throughout the application, data is provided in a number of different formats, and that this data, represents endpoints and starting points, and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

Spatially relative terms, such as “forward”, “rearward”, “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

Additionally, section headings shall not limit or characterize the invention(s) set out in any claims that may issue from this disclosure. Specifically, and by way of example, although the headings refer to a “Technical Field,” such claims should not be limited by the language chosen under this heading to describe the so-called technical field. Further, the description of a technology in the “Background” is not to be construed as an admission that technology is prior art to any invention(s) in this disclosure. Neither is the “Summary” to be considered as a characterization of the invention(s) set forth in issued claims. Furthermore, any reference to this disclosure in general or use of the word “invention” in the singular is not intended to imply any limitation on the scope of the claims set forth below. Multiple inventions may be set forth according to the limitations of the multiple claims issuing from this disclosure, and such claims accordingly define the invention(s), and their equivalents, that are protected thereby.

What is claimed is:

1. A heater for a stovetop heater unit, the heater comprising:
a heating element in a spiral configuration, the heating element comprising:
an innermost coil turn extending, in the spiral configuration, about a central region, the innermost coil turn defining at least a part of a surface heating portion upon which an object is placed to be heated by the heating element;
a temperature sensor positioned within the central region; wherein the central region does not contain the surface heating portion;
wherein a minimum radius of the central region is selected such that the surface heating portion is spaced from the temperature sensor to limit interference with operation of the temperature sensor.

2. The heater of claim 1, wherein the heating element comprises three to four coil turns; and wherein the innermost coil turn is at least one of the three to four coil turns.

3. The heater of claim 1, wherein the minimum radius is equal to a minimum distance between a center of the temperature sensor and the innermost coil turn.

4. The heater of claim 1, wherein the minimum radius of the central region is 45.5 mm to 54.5 mm.

5. The heater of claim 1, wherein a maximum radius of the central region is 54.5 mm and the minimum radius of the central region is 45.5 mm.

6. The heater of claim 1, wherein the minimum radius of the central region is 48.8 mm.

7. The heater of claim 1, further comprising a medallion, the medallion comprising a medallion aperture shaped to allow at least a portion of the temperature sensor to extend through the medallion aperture; wherein a minimum distance between a radially-outward-most surface of the medallion and the innermost coil turn is 16 mm to 25 mm.

8. The heater of claim 1, further comprising a housing configured to surround at least a portion of the temperature sensor; wherein a minimum distance between a radially-outward-most surface of the housing and the innermost coil turn is 16 mm to 25 mm.

9. The heater of claim 1, wherein a maximum radius of the central region is 57.6 mm to 66.6 mm.

10. The heater of claim 1, further comprising:
an outermost coil turn extending, in the spiral configuration, about the central region of the heating element and the innermost coil turn, the outermost coil turn defining at least a part of the surface heating portion.

11. The heater of claim 10, wherein an outermost radius between a center of the central region and the outermost coil turn is 95.2 mm.

12. The heater of claim 10, wherein an outermost radius between a center of the central region and the outermost coil turn is 87.7 mm.

13. The heater of claim 1, further comprising:
a resistive wire configured to generate heat to heat the heating element, the resistive wire extending through at least the innermost coil turn; and
a sheath surrounding the resistive wire.

14. The heater of claim 13, wherein the surface heating portion has a length of 1740 mm.

15. The heater of claim 13, wherein the surface heating portion has a length of 1725 mm to 1755 mm.

16. The heater of claim 1, further comprising an urging element configured to mechanically deform to provide vertical movement of the temperature sensor in response to a downward force applied from the object to the temperature sensor.

17. The heater of claim 16, wherein the urging element comprises:
a plurality of planar sections connected at an angle, the vertical movement being caused by a restorative force to restore the angle between the plurality of planar sections.

18. The heater of claim 1, further comprising a switch configured to prevent a current from conducting through the heating element when the temperature sensor detects a temperature equal to or greater than a temperature threshold.

19. The heater of claim 18, wherein the switch is configured to allow the current to conduct through the heating element when the temperature sensor detects the temperature is less than the threshold temperature.

20. A method of controlling a temperature of a heating surface using the heater of claim 1.
